(19) United States
(12) Patent Application Publication
(10) Pub. No.: US 2008/0298657 A1
(43) Pub. Date: Dec. 4, 2008

(54) Computer-Aided Method for Detection of Interval Changes in Successive Whole-Body Bone Scans and Related Computer Program Program Product and System

(76) Inventors: Junji Shiraishi, Lyons, IL (US); Kunio Doi, Willowbrook, IL (US); Daniel Appelbaum, Chicago, IL (US); Yonglin Pu, Chicago, IL (US); Qiang Li, Naperville, IL (US)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/094,161

(22) PCT Filed: Nov. 22, 2006
(86) PCT No.: PCT/US06/45230

§ 371 Date: May 19, 2008

Related U.S. Application Data
(60) Provisional application No. 60/738,982, filed on Nov. 23, 2005.

(51) Int. Cl. G06K 9/00

(52) U.S. Cl. 382/130

(57) ABSTRACT

A method of producing an image to aid detection of a change in progress of a disease in a patient is described. In the method, a first image of a distribution of a radioisotope in the patient is obtained. A second image of the distribution of the radioisotope in the patient is also obtained. At least one of the first and second images are then normalized (1:140). One of the images is warped to match the other image using a multiple-segment matching method (1:160). The first image is subtracted from the second image to form a subtraction image (1:220). Finally, the resulting subtraction image is displayed.

### CROSS-REFERENCE TO RELATED APPLICATIONS

The present application claims priority to Provisional Application No. 60/738,982 filed Nov. 23, 2005, the contents of which are incorporated herein by reference.

### STATEMENT REGARDING FEDERALLY SPONSORED RESEARCH

The present invention was made in part with U.S. Government support under USPHS Grant Nos. CA062625 and CA098119. The U.S. Government may have certain rights to this invention.

### BACKGROUND OF THE INVENTION

### Field of the Invention

The present invention relates generally to the production of images to aid in the detection of the change in the progress of a disease in a patient.

The present invention also generally relates to computerized techniques for automated analysis of digital images, for example, as disclosed in one or more of U.S. Pat. Nos. 4,839,807; 4,841,555; 4,851,984; 4,875,165; 4,918,534; 5,072,384; 5,150,292; 5,224,177; 5,289,374; 5,319,549; 5,343,390; 5,359,513; 5,452,367; 5,463,548; 5,491,627; 5,537,485; 5,598,481; 5,622,171; 5,638,458; 5,657,362; 5,666,434; 5,673,332; 5,668,888; 5,732,697; 5,740,268; 5,790,690; 5,873,824; 5,881,124; 5,931,780; 5,974,165; 5,982,915; 5,984,870; 5,987,345; 6,011,862; 6,058,322; 6,067,373; 6,075,878; 6,078,680; 6,088,473; 6,112,112; 6,141,437; 6,185,320; 6,205,348; 6,240,201; 6,282,305; 6,282,307; 6,317,617 as well as U.S. patent application Ser. Nos. 08/173,935; 08/398,307 (PCT Publication WO 96/27846); Ser. Nos. 08/536,149; 08/900,189; 09/027,468; 09/141,535; 09/471,088; 09/692,218; 09/716,335; 09/759,333; 09/760,854; 09/773,636; 09/816,217; 09/830,562; 09/818,831; 09/842,860; 09/860,574; 60/160,790; 60/176,304; 60/329,322; 09/990,311; 09/990,310; 09/990,377; 10/360,814; and 60/331,995; and PCT patent applications PCT/US98/15165; PCT/US98/24933; PCT/US99/03287; PCT/US00/41299; PCT/US01/00680; PCT/US01/01478 and PCT/US01/01479, all of which are incorporated herein by reference.

The present invention includes the use of various technologies referenced and described in the above-noted U.S. patents and applications, as well as described in the documents identified in the following LIST OF REFERENCES, which are cited throughout the specification by the corresponding reference number in brackets:

### LIST OF REFERENCES

(1) UNSCEAR 2000. Report to the General Assembly, with Scientific Annexes. United Nations Scientific Committee on the Effects of Atomic Radiation., New York.
(2) A. Kano, K. Doi, H. MacMahon, D. D. Hassell, and M. L. Giger, “Digital image subtraction of temporally sequential chest images for detection of interval change,” Med. Phys. 21, 453-461 (1994).
(3) T. Ishida, S. Katsuragawa, K. Nakamura, H. MacMahon, and K. Doi, “Iterative image warping technique for temporal subtraction of sequential chest radiographs to detect interval change,” Med. Phys. 26, 1320-1329 (1999).
(4) T. Ishida, K. Ashizawa, R. Engelmaim, S. Katsuragawa, H. MacMahon, and K. Doi, “Application of temporal subtraction for detection of interval changes on chest radiographs: improvement of subtraction images using automated initial image matching,” J. Digit. Imaging 12, 77-86 (1999).
(5) M. C. Difazio, H. MacMahon, X. W. Xu, P. Tsai, J. Shiraishi, S. G. Armato, 3rd, and K. Doi, “Digital chest radiography: effect of temporal subtraction images on detection accuracy,” Radiology 202, 447-452 (1997).
(6) T. Johkoh, T. Kozuka, N. Tomiyama, S. Hanada, O. Honda, N. Mihara, M. Koyama, M. Tsubamoto, M. Maeda, H. Nakamura, H. Saki, and K. Fujiwara, “Temporal subtraction for detection of solitary pulmonary nodules on chest radiographs: evaluation of a commercially available computer-aided diagnosis system,” Radiology 223, 806-811 (2002).
(7) S. Kakeda, K. Nakamura, K. Kamada, H. Watanabe, H. Nakata, S. Katsuragawa, and K. Doi, “Improved detection of lung nodules by using a temporal subtraction technique,” Radiology 224, 145-151 (2002).
(8) M. Tsubamoto, T. Johkoh, T. Kozuka, N. Tomiyama, S. Hamada, O. Honda, N. Mihara, M. Koyama, M. Maeda, H. Nakamura, and K. Fujiwara, “Temporal subtraction for the detection of hazy pulmonary opacities on chest radiography,” AJR Am. J. Roentgenol. 179, 467-471 (2002).
(9) H. Abe, T. Ishida, J. Shiraishi, F. Li, S. Katsuragawa, S. Sone, H. MacMahon, and K. Doi, “Effect of temporal subtraction images on radiologists' detection of lung cancer on CT: results of the observer performance study with use of film computed tomography images,” Acad. Radiol. 11, 1337-1343 (2004).
(10) E. Ilkko, K. Suomi, A. Karttunen, and O. Tervonen, “Computer-assisted diagnosis by temporal subtraction in postoperative brain tumor patients: a feasibility study,” Acad. Radiol. 11, 887-893 (2004).
(11) Q. Li, S. Katsuragawa, and K. Doi, “Improved contralateral subtraction images by use of elastic matching technique,” Med. Phys. 27, 1934-1942 (2000).
(12) M. L. Giger, K. Doi, and H. MacMahon, “Image feature analysis and computer-aided diagnosis in digital radiography. 3. Automated detection of nodules in peripheral lung fields,” Med. Phys. 15, 158-166 (1988).
(13) Y. C. Wu, K. Doi, M. L. Giger, C. E. Metz, and W. Zhang, “Reduction of false positives in computerized detection of lung nodules in chest radiographs using artificial neural networks, discriminant analysis, and a rule-based scheme,” J. Digit. Imaging 7, 196-207 (1994).
(14) K. Doi, “Overview on research and development of computer-aided diagnostic schemes,” Semin. Ultrasound CT MR 25, 404-410 (2004).
(15) K. Doi, “Current status and future potential of computer-aided diagnosis in medical imaging,” Br. J. Radiol. 78 Spec No 1, S3-S19 (2005).
(16) H. P. Chan, B. Sahiner, R. F. Wagner, and N. Petrick, “Classifier design for computer-aided diagnosis: effects of finite sample size on the mean performance of classical and neural network classifiers,” Med. Phys. 26, 2654-2668 (1999).

The contents of each of these references, including the above-mentioned patents and patent applications, are incorporated herein by reference. The techniques disclosed in the patents, patent applications, and other references can be utilized as part of the present invention.

### DISCUSSION OF THE BACKGROUND

Bone scintigraphy is the most frequent examination among various diagnostic nuclear medicine procedures. Bone scans are commonly used for imaging of new bone formation that may occur due to the presence of almost any skeletal pathology, and for demonstrating increased and/or decreased gamma-ray emissions localized at the sites of bone abnormalities. Although the sensitivity of bone scan examinations for detection of bone abnormalities has been considered to be very high, it is time-consuming to identify multiple lesions such as bone metastases of prostate and breast cancers. In addition, because of variations in patient conditions, the accumulation of radioisotopes during each examination, and the image quality of gamma cameras, it is difficult to detect subtle changes between two successive abnormal bone scans.

As shown in FIG. 12, according to an UNSCEAR report which included the results of a comprehensive survey of radiology practice worldwide [1], bone scintigraphy accounted for 24.0% of all diagnostic nuclear medicine procedures for the period 1991-1996 in the specific country group of health care level I in which a country has more than one physician per 1000 population. Bone scans are commonly used for imaging of new bone formation that may occur due to the presence of almost any skeletal pathology, and for demonstrating increased and/or decreased gamma ray emissions localized to the site of bone abnormalities by use of the radioisotope of technetium-99m methylene diphosphonate as is illustrated in FIG. 13. Thus, the bone scan has been applied as an initial procedure for identifying several disorders such as skeletal metastases, osteosarcoma, osteomyclitis, and nondisplaced fractures. The sensitivity of bone scan examinations for detection of bone abnormalities has been considered to be very high; however, it is time-consuming to identify multiple lesions such as bone metastases of prostate and breast cancers. In addition, because of variations in patient conditions, the accumulation of radioisotopes during each examination, and the image quality of gamma cameras, it is difficult to detect subtle changes between two successive abnormal bone scans. Therefore, the inventors have recognized as one aspect of the present invention that a computerized method that can assist radiologists in the detection and/or quantification of interval changes in successive bone scans would be useful by reducing the interpretation time and by quantifying the extent of an increase or a decrease in the radioisotope uptake between two different bone scans.

A temporal subtraction technique has been employed for detection of interval changes between two successive chest images [2-4]. For reducing registration artifacts in temporal subtraction images of two successive chest radiographs, a nonlinear image-warping technique was developed for temporal subtraction schemes [2-4]. Several temporal subtraction techniques have been applied to chest radiographs [5-8], chest CT images [9], and brain MRI images [10]; however, to the inventor's knowledge there has been no application of a temporal subtraction scheme by use of the nonlinear image-warping technique for bone scintigrams. In addition, to the inventor's knowledge there has been no approach to developing a computer-aided diagnostic (CAD) method for the detection of interval changes in successive bone scans and in other images obtained from any diagnostic nuclear medicine procedures.

### SUMMARY OF THE INVENTION

Accordingly, one object of the present invention is to provide a method of producing an image to aid detection of a change in progress of a disease in a patient. In the method, a first image of the distribution of a radioisotope in the patient is obtained. A second image of the distribution of the radioisotope in the patient is then obtained. At least one of the first and second images are normalized. One of the images is then warped to match the other image using a multiple-segment matching method. The first image is subtracted from the second image to form a subtraction image and finally the resulting subtraction image displayed.

Another object of the present invention is to provide another method of producing an image to aid detection of a change in progress of a disease in a patient. In this method, a first image of a distribution of a radioisotope in the patient is obtained. The first image is segmented into plural first segments. A second image of the distribution of the radioisotope in the patient is then obtained and the second image is also segmented into plural second segments. The first segments are then matched to a corresponding segment in the second image using first and second segments. The size of the first segment is magnified or reduced to match the size of the corresponding segment in the second image. Each segment is normalized and a multiple-step image warping technique is applied to each segment. The segments of the first image are then subtracted from corresponding segments of the second image to form plural subtraction images which are combined and displayed.

### BRIEF DESCRIPTION OF THE DRAWINGS

Amore complete appreciation of the invention and many of the attendant advantages thereof will be readily obtained as the same becomes better understood by reference to the following detailed description when considered in connection with the accompanying drawings, in which like reference numerals refer to identical or corresponding parts throughout the several views, and in which:

FIG. 1: illustrates a first embodiment of the overall computerized method for the detection of interval changes between two successive whole-body bone scans;

FIG. 2: illustrates an example of whole-body bone scan images for posterior view, (a) original raw image data, (b) input image, (c) normalized image, (d) image matched regarding size, orientation, and gray scale, and (e) the current normalized image;

FIG. 3: illustrates a relationship between the rank order of identified high-intensity regions and the average pixel values for posterior-view bone scan image, the mean (P) of the average pixel values of 5 identified normal regions was used for determining the normalization factor (F=k/P), where k is 358 and 410 for anterior and posterior views, respectively;

FIG. 4: illustrates a relationship between average pixel values of ROIs in the previous and current images, the slope a and the intersection b were estimated from the correlation of the pixel values of the previous image (P(x,y)) and the pixel values of the current image (C(x,y));

FIG. 5: illustrates examples of (a) normalized and matched previous image, (b) nonlinear warped image obtained from matched image corresponding to (c) normalized current image, and (d) temporal subtraction image obtained by subtraction of (b) the previous image from (c) the current image;

FIG. 6: illustrates an example of (a) hot-lesion enhanced image and (b) initial candidates of interval changes obtained in the initial identification, both hot (marked in black) and cold (marked in white) lesions are displayed;

FIG. 7: illustrates examples of normalized and matched previous images, normalized current images, and their temporal subtraction images for both anterior and posterior view, (a) new subtle symmetric abnormal findings on sacral-iliac lesions in the current image, and (b) the location of the left kidney was changed from the previous scan which may reflect adjacent soft-tissue pathology.

FIG. 8: illustrates temporal subtraction images for anterior and posterior views obtained (a) without and (b) with nonlinear image warping technique;

FIG. 9: illustrates an example of a case of multiple bone metastases (more than 20 interval changes), there are numerous lesions at baseline with interval hot and cold areas, which would be time-consuming and difficult to characterize without a temporal subtraction image;

FIG. 10: shows a list of image features obtained at the initial identification on hot/cold-lesion enhanced images, including image features obtained from the warped previous and the current images;

FIG. 11: shows the number of “gold standard” interval changes in each view and in each hot or cold lesion, and the performance of the computerized method in terms of sensitivity and false positives per view for the 58 pairs of successive whole-body bone scans;

FIG. 12: illustrates the frequency of bone scans in diagnostic nuclear medicine procedures;

FIG. 13: illustrates the procedure of a bone scan, fist inject 99 mTc-HDP 3 to 4 hours before scanning and then scan with Gamma Camera;

FIG. 14: shows examples of a full body scans which were considered to be difficult to identify interval changes due to multiple lesions, changes in size, gray scale and patient positioning;

FIG. 15: illustrates the number of interval changes per case for the 58 patients (107 total changes);

FIG. 16: illustrates image matching, the size, orientation, and gray scale of the previous image were modified to match with those of the current image;

FIG. 17: illustrates temporal subtraction image using nonlinear image-warping technique;

FIG. 18: is another example illustrating temporal subtraction image using nonlinear image-warping technique;

FIG. 19: illustrates the initial identification of interval changes, where the image feature extraction is performed using the current image, the previous image and the subtraction image;

FIG. 20: illustrates the original successive bone scan images in anterior and posterior views of a first case;

FIG. 21: illustrates the temporal subtraction images obtained by nonlinear image warping technique in a first case;

FIG. 22: illustrates the computerized detection of interval changes in successive bone scan images in a first case;

FIG. 23: illustrates the original successive bone scan images in anterior and posterior views of a second case;

FIG. 24: illustrates the temporal subtraction images obtained by nonlinear image warping technique in a second case;

FIG. 25: illustrates the computerized detection of interval changes in successive bone scan images in a second case;

FIG. 26: illustrates the original successive bone scan images in anterior and posterior views of a third case;

FIG. 27: illustrates the temporal subtraction images obtained by nonlinear image warping technique in a third case; and

FIG. 28: illustrates the computerized detection of interval changes in successive bone scan images in a third case.

### DETAILED DESCRIPTION OF THE PREFERRED EMBODIMENTS

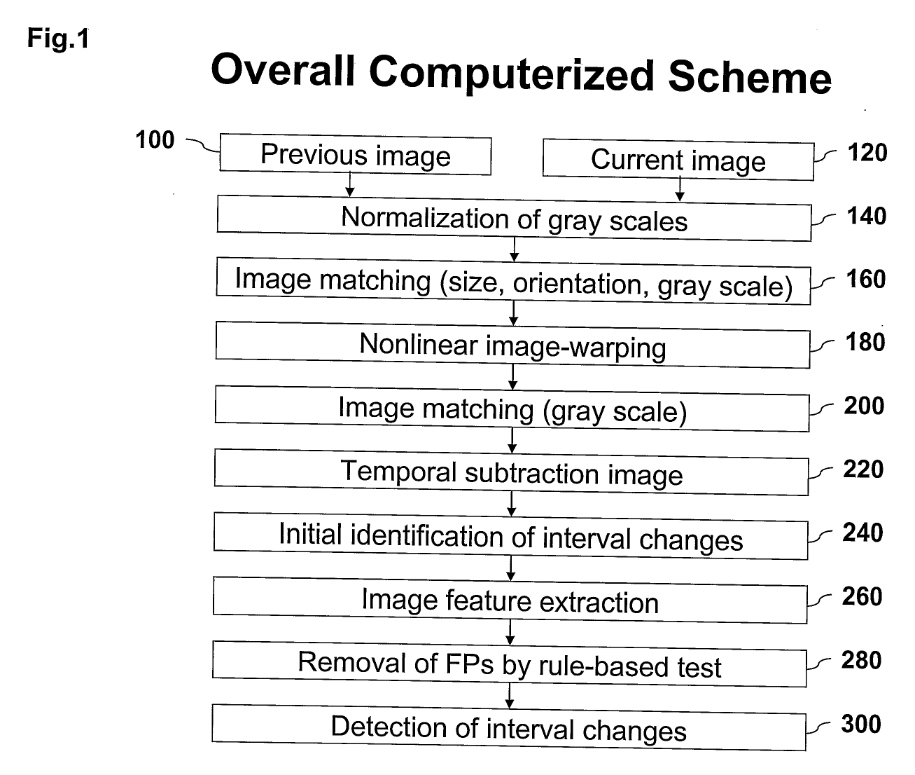

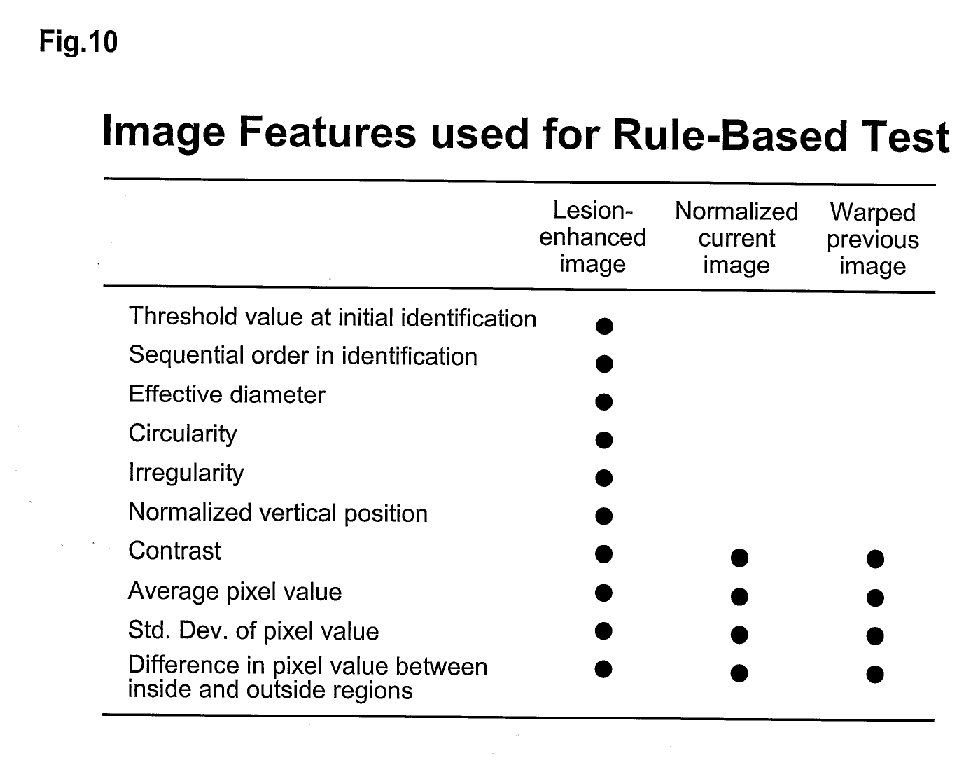

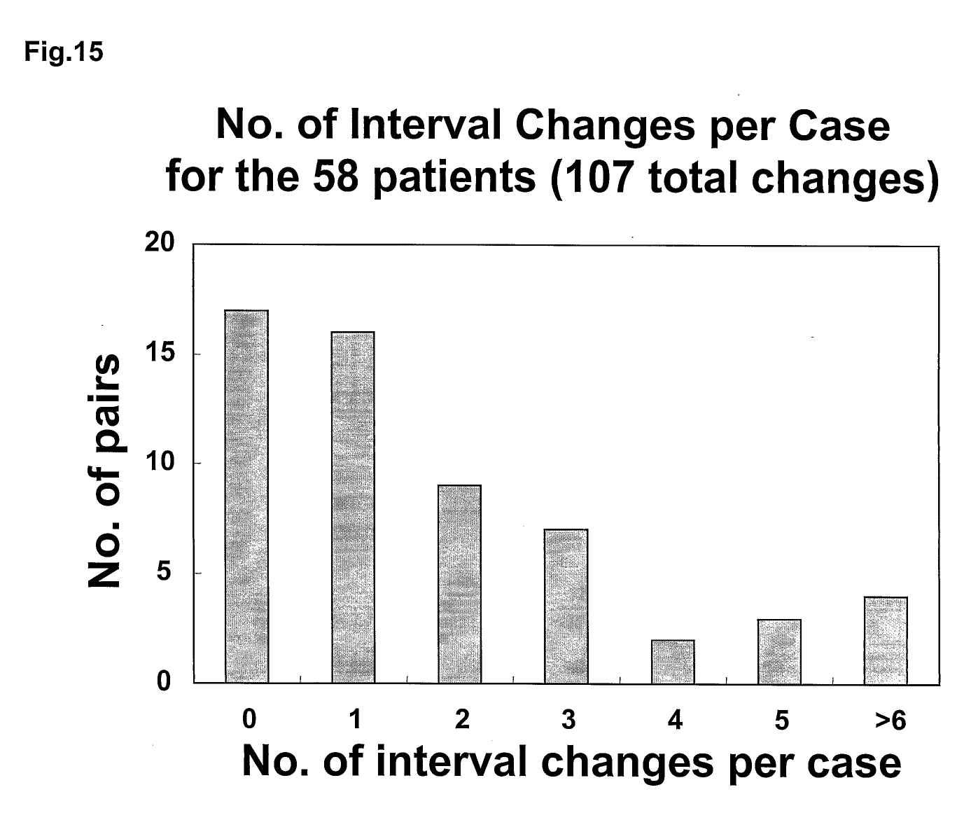

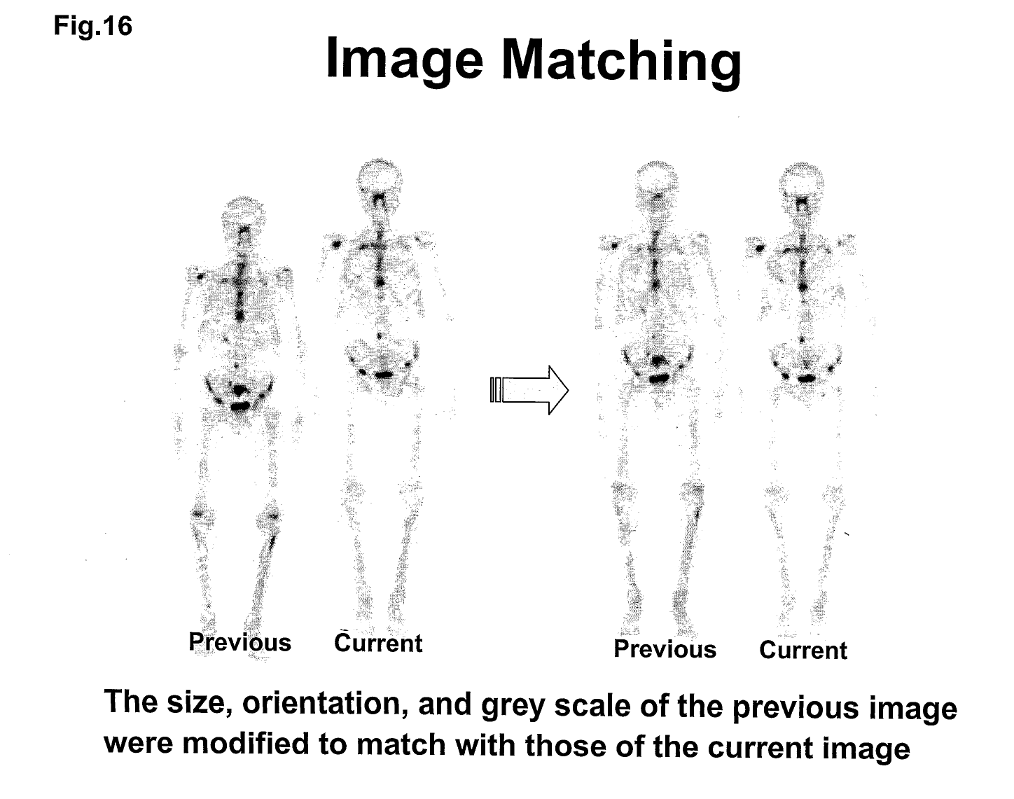

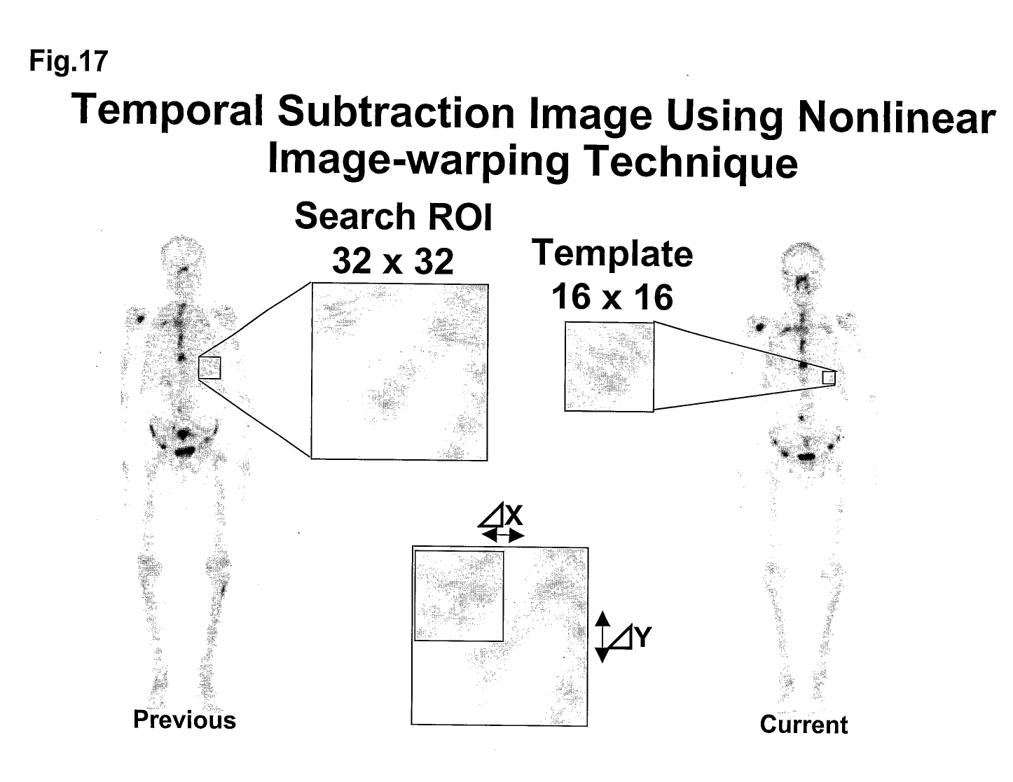

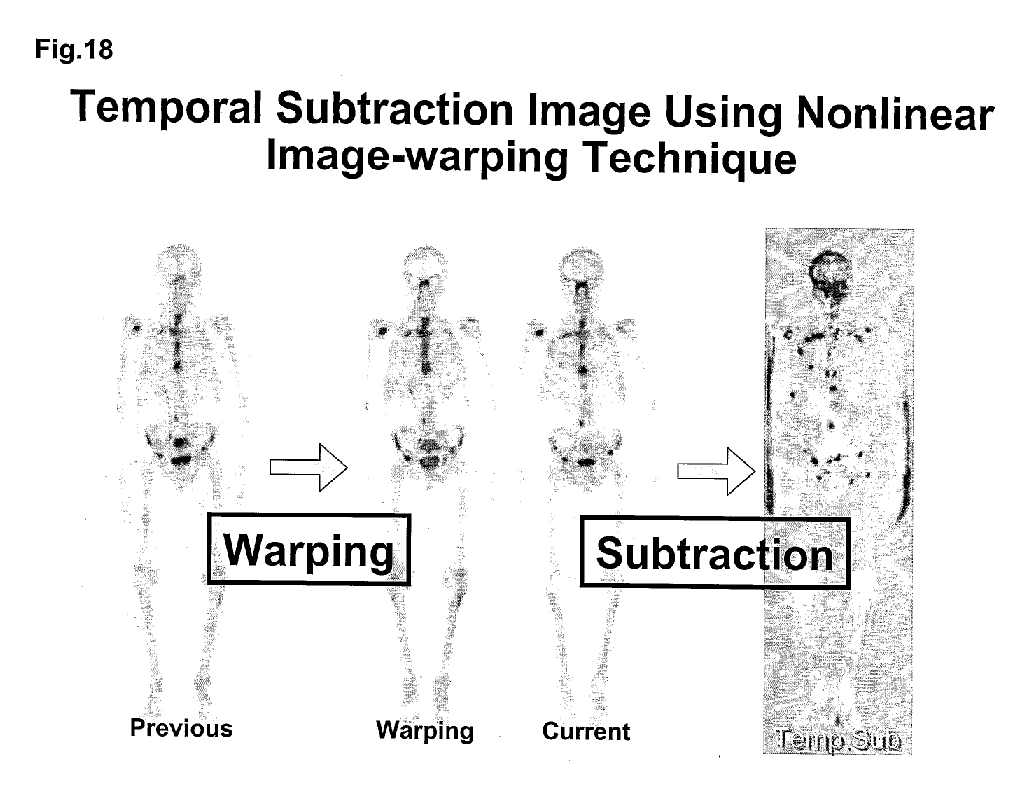

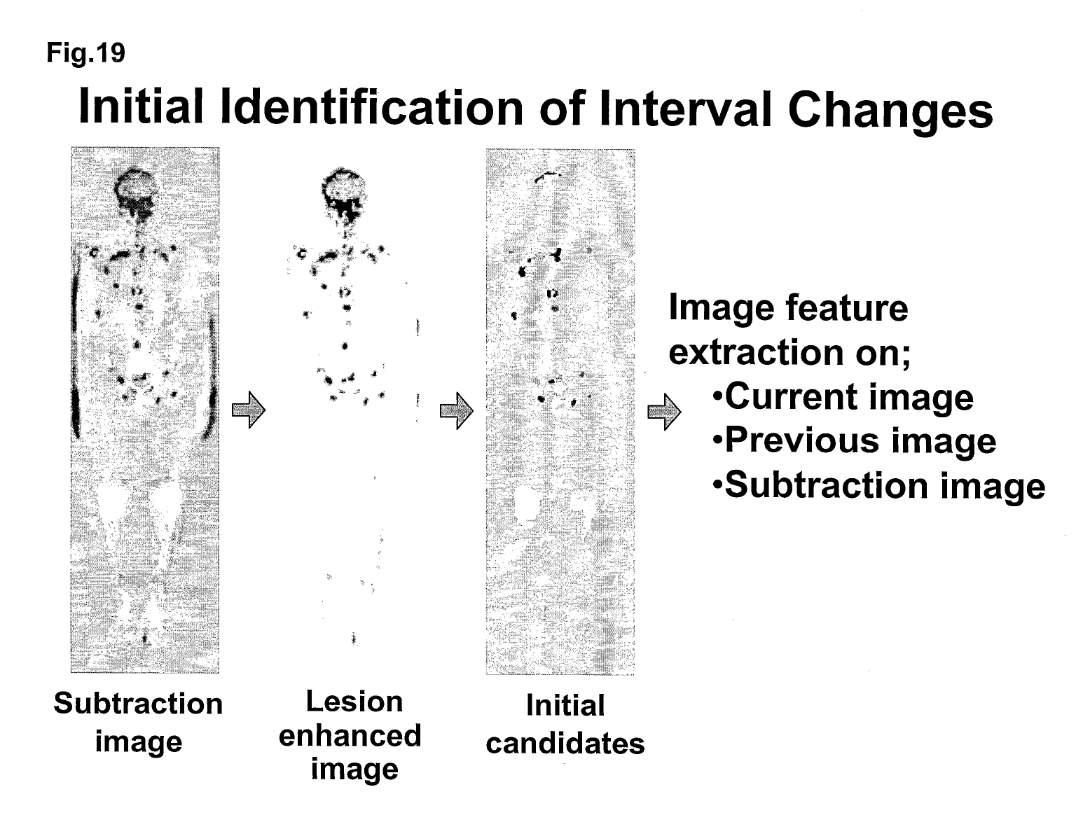

One embodiment of a computerized method for the production of images to aid in the detection of the change in the progress of a disease in a patient is discussed herewith. For example, in one embodiment of the present invention a new computer-aided diagnostic (CAD) method for the detection of interval changes in successive whole-body bone scans by use of a temporal subtraction image was developed, FIG. 15 illustrates an example of a full body scan. The method uses a nonlinear image-warping technique. Fifty-eight pairs of successive bone scans were carried out in which each scan included both posterior and anterior views obtained simultaneously by use of a set of two gamma cameras placed face-to-face. Inclusion criteria for these cases, which were selected from a total of 1038 bone scintigrams (examined in 2004), were; 1) at least one abnormal finding in either view, 2) a maximum number of 20 interval changes, and 3) one image pair per patient. As shown in FIG. 15, it was determined that 107 was the “gold-standard” interval change number among the 58 pairs based on the consensus of three radiologists. As shown in FIG. 1, the computerized method may include seven steps, for example, initial image density normalization on each image 140, image matching for the paired images 160 shown in FIG. 16, temporal subtraction by use of the nonlinear image-warping technique 180 shown in FIGS. 17 and 18, initial detection of interval changes 240 by use of temporal-subtraction images 220 shown in FIG. 19, image feature extraction of candidates of interval changes 260, rule-based tests 280 by use of the image features for removing some false positives shown in FIG. 10, and display of the computer output for identified interval changes 300 in terms of the combination of all candidates obtained from the anterior and posterior views, other steps are also possible. One hundred seven “gold standard” interval changes included 95 hot lesions (uptake was increased compared with the previous scan, or there was new uptake in the current scan) and 41 cold lesions (uptake was decreased or disappeared) for anterior and posterior views. Some lesions which could be identified in both views were counted as single “gold standard” for each case. The overall sensitivity in the detection of interval changes, including both hot and cold lesions, in the 58 successive bone scan pairs was 95.3%, with 5.78 false positives per view. The temporal subtraction image for successive whole-body bone scans has the potential to enhance the interval changes between two images, which also can be quantified. Furthermore, the CAD method for the detection of interval changes by use of temporal subtraction images is useful in assisting radiologists' interpretation on successive bone scan images.

In the present embodiment an image database was used. In addition 58 pairs of successive bone scans were used in which each scan included both posterior and anterior views obtained simultaneously by use of a set of two gamma cameras placed face-to-face. First seventy cases were randomly selected from a total of 1038 bone scintigrams (examined in 2004) by two radiologists (YN and FL); then, 58 cases were selected with several inclusion criteria determined by two other radiologists (DA and YP), as follows: 1) at least one abnormal finding in either view, 2) a maximum number of 20 interval changes, and 3) one image pair per patient. In order to determine a “gold standard” for interval changes for all cases, an observer study was performed in which interval changes in either a hot lesion (uptake was increased compared with the previous scan or new uptake in the current scan) or a cold lesion (uptake was decreased or disappeared) were identified. Three experienced radiologists (DA, YP, and HA) participated in the observer study, which was performed independently by use of a PC-based computer interface. The interface allowed the radiologists to identify locations and types (hot/cold) of interval changes and compare them with the previous and the current anterior/posterior images which were displayed on a LCD monitor. Finally, the 107 “gold standard” interval changes were determined from among the 58 pairs based on agreement of the three radiologists as to both locations and types of lesions. The one hundred seven “gold standard” interval changes included 71 hot lesions and 36 cold lesions for anterior and posterior views. Some lesions which could be identified in both views were counted as a single “gold standard” for each case. The average number of interval changes for the 58 pairs was 1.85 (range: 0-11), and 17 of the 58 pairs had no interval change, whereas all cases included one or more abnormalities in at least one view.

FIG. 1 illustrates one embodiment of the method. In this embodiment, an overall computerized method for the detection of interval changes on successive whole-body bone scan pairs by use of a temporal subtraction image procedure is illustrated. For application of a nonlinear image-warping technique to the temporal subtraction image, the gray scale of each image (previous 100 and current 120 images) was normalized first 140, and then the size, orientation and gray scale of a previous image were adjusted 160 to match those of a current image.

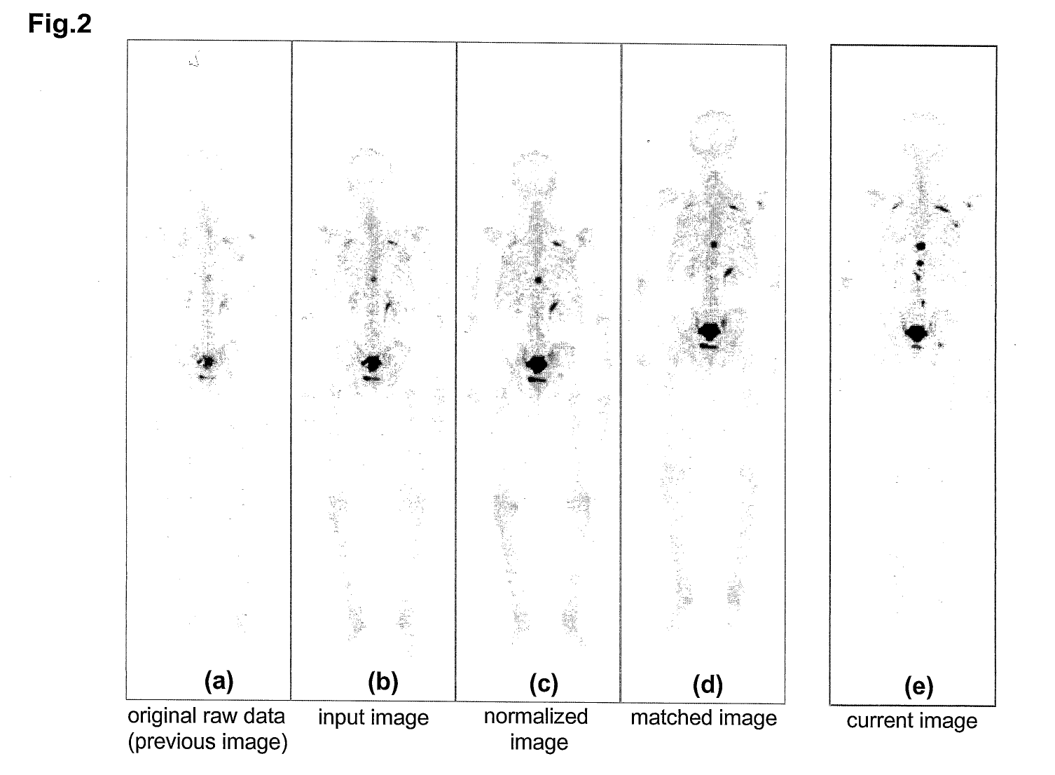

As is common in whole-body bone scintigrams, residual radioactive urine in the bladder and/or a leakage at the injection site has caused extremely high intensities on bone scan images. These high intensities frequently prevent a proper display of bone scan images of clinical interest. Therefore, for optimizing the density level of the output images, all input images (256×1024 matrix size and 10-bit gray scale) for the computerized method were converted in advance from the original gray scale (16-bit) of each of the raw image data by use of a histogram analysis for removal of areas with extremely high intensities. In this gray-scale conversion method, the pixel values in the upper 0.2% and 98% of the area under the histogram of the original raw image data were linearly mapped to 1023 and 0, respectively, in the current image. FIG. 2 shows an example of posterior views of (a) original raw image data and (b) a converted input image for the computerized method. The dynamic range of pixel values in the input image was generally decreased from the raw image data by use of this conversion method, such that the contrast of clinical interest in the input image was increased. The raw image data had two different pixel sizes (2.18 mm and 1.98 mm) for the two different gamma cameras. However, it was assumed that the input image had the same pixel size of 2.0 mm for all images without any conversion in pixel size from the raw image data; less than 20% of errors in pixel size would be negligible in the low-resolution images of whole-body bone scans, and all pixel sizes of previous images would be adjusted in the image-matching process which will be described later.

In addition to the effect of high intensities caused by urine and/or leakage at the site of injection, high intensities for bone abnormalities occasionally affect the optimization of the gray scale of bone scan images. For example, normal bone structures represented relatively low pixel values in the abnormal bone scan images compared with those in the normal bone scan images. In order to reduce the effect of high-intensity lesions on bone scan images for optimization of the gray scale, an average pixel value of normal bone structures to normalize the gray scale of each image was used. In this gray-scale normalization, a multiple thresholding method [12] was applied for the area under the histogram of the input image to identify initially a number of high-intensity regions, which included all abnormal lesions and some normal areas. Once a number of high-intensity regions were identified, the average pixel values for all of these regions were analyzed by a multiple thresholding method in order to determine the transition point which corresponds to the threshold pixel value for distinguishing between abnormal lesions and normal areas (i.e., normal bone structures) with very high intensities. With this method, all identified areas were sorted first based on the order (ranking) of their average pixel values.

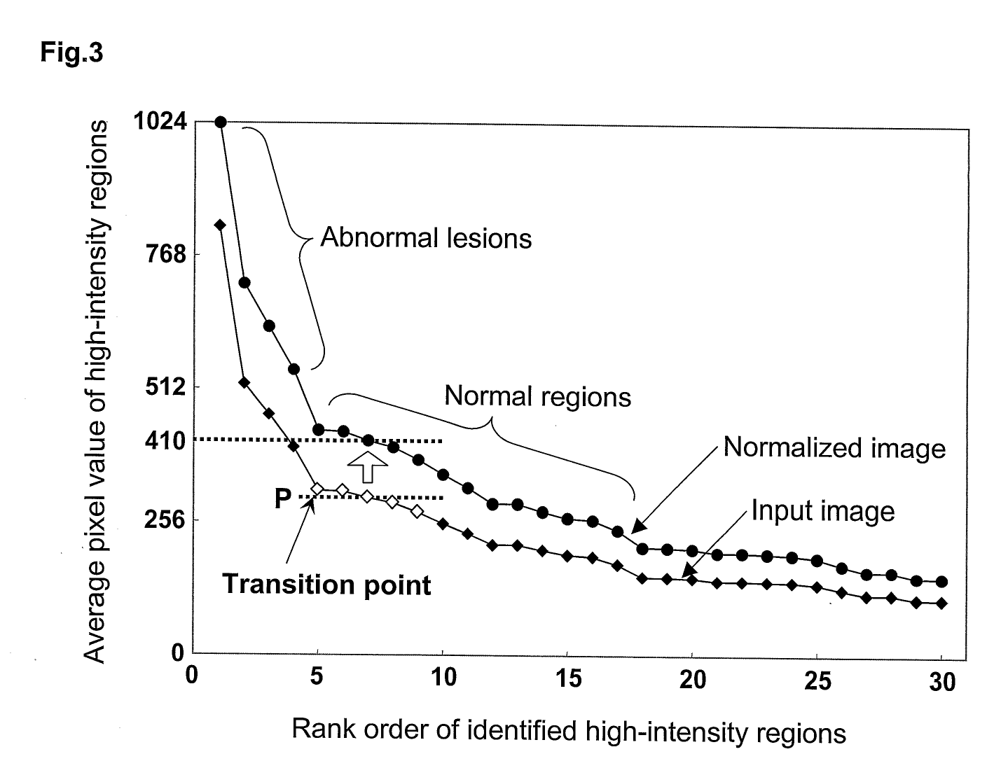

FIG. 3 shows the relationship between the rank order of identified areas and the average pixel values for the posterior view of the bone scan image illustrated in FIG. 2. The transition point was determined based on a large change in the average pixel values between the group of abnormal lesions and the group of normal areas. Note that the variation in the average pixel values in normal areas is relatively small. The mean (P) of the average pixel values of five identified normal areas whose average pixel values were immediately below the transition point were used. The pixel values in a normalized image were determined by the product of a normalization factor (F) and the original pixel value of an input image. The F value was determined by k/P, where k was selected empirically as 358 (35% of the maximum gray scale of 1024) for the anterior view and 410 (40% of the maximum gray scale of 1024) for the posterior view. FIG. 2 shows posterior views of (b) an input image and (c) a normalized image.

In the next step, after each image gray scale was normalized 140, the previous image 100 to the current image 120 in terms of the image size, orientation, and gray scale, were matched 160 in order to minimize the difference between the two images for visual comparison and for the application of a nonlinear image warping technique for obtaining the temporal subtraction image. The horizontal profiles of the previous 100 and the current 120 image were used for determining the top and bottom positions, and the mid-line of the body projections, and then the magnification/minification and the orientation of the previous image 100 were made to match those of the current image 120.

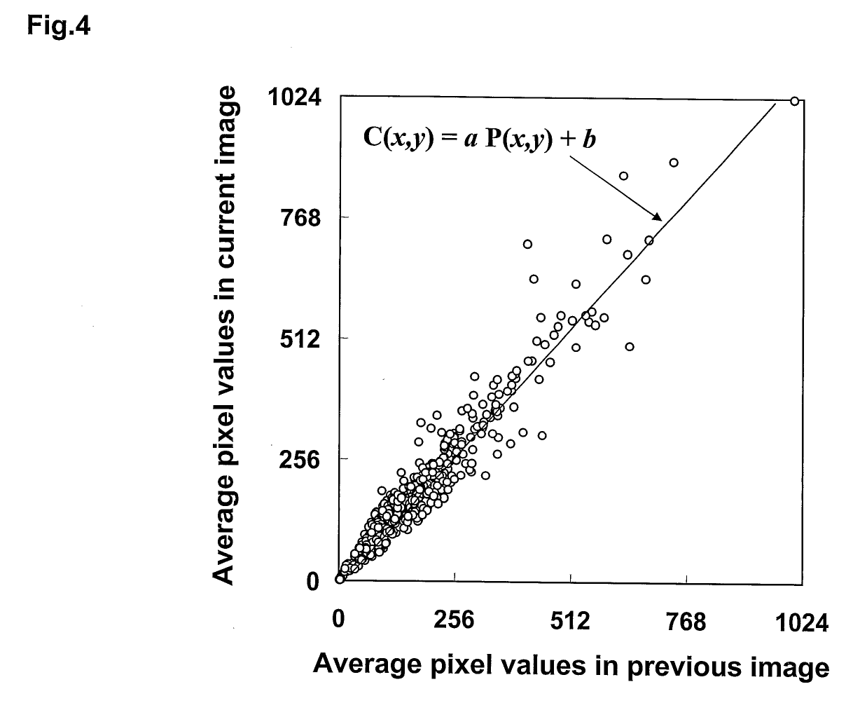

The gray scale of the previous image 100 was matched to that of the current image 120 by analysis of the correlation between the average pixel values of the corresponding small regions of interest (“ROIs”) (16×16 matrix size) in the two images. FIG. 4 shows the relationship between the average pixel values in the previous and the current images, which were shown in FIG. 2. A regression line for the relationship between the average pixel values in the previous and the current images were estimated. Then the pixel values of the previous image were converted linearly by use of the slope a and the intersection b which were obtained from the estimated regression line. FIG. 2 shows posterior views of (c) the normalized image and (d) the matched image of the previous scan, which should be compared to (e) the normalized image of the current posterior view. Some ROIs for this normalization process were excluded when the difference in the average pixel value between the two ROIs in the previous and the current images was more than 50% of the average value of the ROI in the current image. This is because some ROIs included actual interval changes, so that the correlation in the average pixel values between such ROIs would be very low.

A nonlinear image-warping technique 180 which was developed for the contralateral subtraction technique in chest radiographs [11] was employed, and was modified for bone scan images, in order to reduce misregistration artifacts in the subtraction image. Such artifacts may be due to the difference in patient conditions, patient positioning, and the equipment used for examinations.

Further a global matching was used 200. The purpose of global matching was to register the previous and current images approximately, so that the subsequent local matching and image-warping technique, described later, could provide improved subtraction images and could also be more efficient. First, the matrix size of the previous and current images was reduced by 50% by using a sub-sampling technique. All of the processing steps in the global matching were then applied to only the reduced image.

The global matching technique was based on multiple small ROIs distributed over the entire 2-D image space. In the previous image, many template ROIs 20×20 in size were determined, and in the current image, many search area ROIs of the size 44×108 were determined. The center of a template ROI in the current image was equal to the center of the corresponding search area ROI in the previous image. The distance between the adjacent ROIs was 10 pixels for the templates and the search areas. Please note that the search area is preferably a rectangle, because the possible shift value in the vertical direction is generally much larger than that in the horizontal direction, however other shapes may also be used.

For a given shift vector, a template was shifted by the shift vector and a corresponding region was determined inside the search area. The cross correlation between the shifted template and the corresponding region inside the search area may also be determined. For each of all possible shift vectors, the similarity between the previous and current images can be defined as the sum of correlation values between all shifted templates and the corresponding regions in the search areas. The shift vector with the maximum correlation value (similarity) between the previous and current images is determined as the “optimal” shift vector for the two images. This optimal shift vector can then multiplied by two and can be used to shift the full-size previous image so that the two images match approximately.

However, the previous image may be slightly scaled and/or rotated relative to the current image. To take this factor into the global matching, 15 (5×3) scaled and rotated versions of the previous image with 5 scaling factors (0.9, 0.95, 1.0, 1.05, 1.1) and 3 rotation angles (−1, 0, 1 degree) can be produced. Among the 15 transformed versions of the previous image, that providing the largest similarity with the current image may be preferably selected and employed in the subsequent processing.

After the global matching 200, the two images are registered approximately. However, the corresponding legs in the two images are often still far from each other in the horizontal direction. This makes the matching of the legs in the two images very difficult and makes the legs the main source of misregistration artifacts. To address this problem, the legs were approximately matched with respect to the two images with a simple technique described below.

First, the body of patient in the two images is delineated by use of a thresholding segmentation technique. The threshold is determined empirically such that the total area of the object pixels in the segmented image (with a value of 1) is equal to 65% of the image size. The subsequent processing steps in this section are restricted to the segmented binary image unless otherwise stated. It should be noted that the segmentation result does not need to be very accurate for the approximate matching of legs. All isolated objects are then labeled and only the one with the largest area is retained. This largest object corresponds to the body of a patient. Further, a sub-region is obtained in the segmented images which contains the lower 35% (in height) of the body. For example, if the height of the body is 800 pixels, then the height of the sub-region, which is located at the bottom of the body, is 800×0.35=280 pixels.

First the leg on the left side of the two images is registered. It can be right leg or left leg depending on whether the bone scan is acquired on the anterior or posterior side. To determine the leg on the left, the left 55% of the above-mentioned sub-region is retained and the right 45% of the sub-region is removed. In the remaining left region, all isolated objects are labeled and the largest one is retained. The largest object corresponds to the leg on the left. The central line (known as medial line or skeleton in computer vision) of the leg is determined by identifying the central point of object pixels in each row of the sub-regions. The shift value in the horizontal direction for each row is defined as the displacement of the two central points for the row in the two images. It should be noted that only the horizontal shift value is used because the legs in the two images are generally away from each other in the horizontal direction.

Once the shift values for each row of the sub-regions are determined, a 3-point average smoothing method is used 100 times to smooth the shift values. The smoothed shift values are then used for shifting the leg on the left in the previous image. A technique similar to that described above is used for shifting the legs on the right of the two images so that they can match. The only difference is now to retain the right 55%, instead of the left 55%, of the sub-region, in which the leg on the right will be included.

The local image-matching and -warping technique tries to register accurately the two images that are roughly matched by use of global matching and leg matching. It should be noted that any multiple-step image warping technique may consist of initial global warping as well as local accurate warping. The local image-matching and -warping technique consists of three steps. The first step is the automatic selection of many template ROIs in the previous image and many search area ROIs in the current image. In this study, the matrix sizes of the template ROIs and the search area ROIs are 12×12 and 24×24, respectively. The distance between the adjacent ROIs is 8 pixels. Therefore, there is 33.3% and 66.7% overlap between two adjacent template ROIs and two adjacent search area ROIs, respectively.

The second step is the determination of cross-correlation values between template ROIs and the corresponding search area ROIs for measuring the similarities between the template ROIs and the search area ROIs. A shift vector indicates a shift in the location of a template ROI (12×12 pixels) to be matched with a corresponding local region (12×12 pixels) included in the search area ROI (24×24 pixels), and a correlation value indicates the extent of the similarity between the shifted template and the corresponding region of the search area. In this study, an array of correlation values for a given template ROI with all possible shift vectors is obtained for iteratively determining the final shift vector by application of the elastic matching technique [11].

The third step is the determination of final shift vectors for the template ROIs by use of the elastic matching technique [11]. The elastic matching technique iteratively updates the shift vectors by taking into account the cross correlation values and the consistency and/or smoothness between adjacent shift vectors. Therefore, the elastic matching technique iteratively changes the current shift vector for each ROI according to two measures. The first measure, or the internal energy, is to examine the consistency (smoothness) of the local shift vectors, which is given here by the squared sum of the first and the second derivatives over the local shift vectors. The smoother the local shift vectors, the smaller the internal energy will be. The second measure, or the external energy, is equal to the negative value of the cross-correlation value, so that a shift vector with a large correlation value provides a small external energy. The local energy for a given template ROI is thus defined as the weighted sum of the internal and external energies.

The objective for the elastic matching technique is to minimize the total energy over the entire image, which is given by the sum of the local energies for all template ROIs. The initial shift vector for each ROI can be selected arbitrarily, and in this study, it was taken to be the one with the maximum correlation value. The shift vectors are then updated by use of a greedy algorithm [11]. At a specific iteration, the shift vector for a template ROI is assumed to be represented by a 2-D vector (dx,dy). With the greedy algorithm, the new shift vector for the template ROI at the next iteration is selected as the one with the minimum local energy among (2N+1)×(2N+1) possible shift vectors, i.e., the (2N+1)×(2N+1) combinations of (2N+1) X-shift values {dx−N, dx−N+1, . . . , dx+N−1, dx+N} and (2N+1) Y-shift values {dy−N, dy−N+1, . . . , dy+N−1, dy+N}. In this study, N was determined empirically to be four. This procedure is applied to each of the template ROIs for an iteration of update of the shift vectors, and is repeated several times over the entire image until no more than one percent of shift vectors in all ROIs are updated.

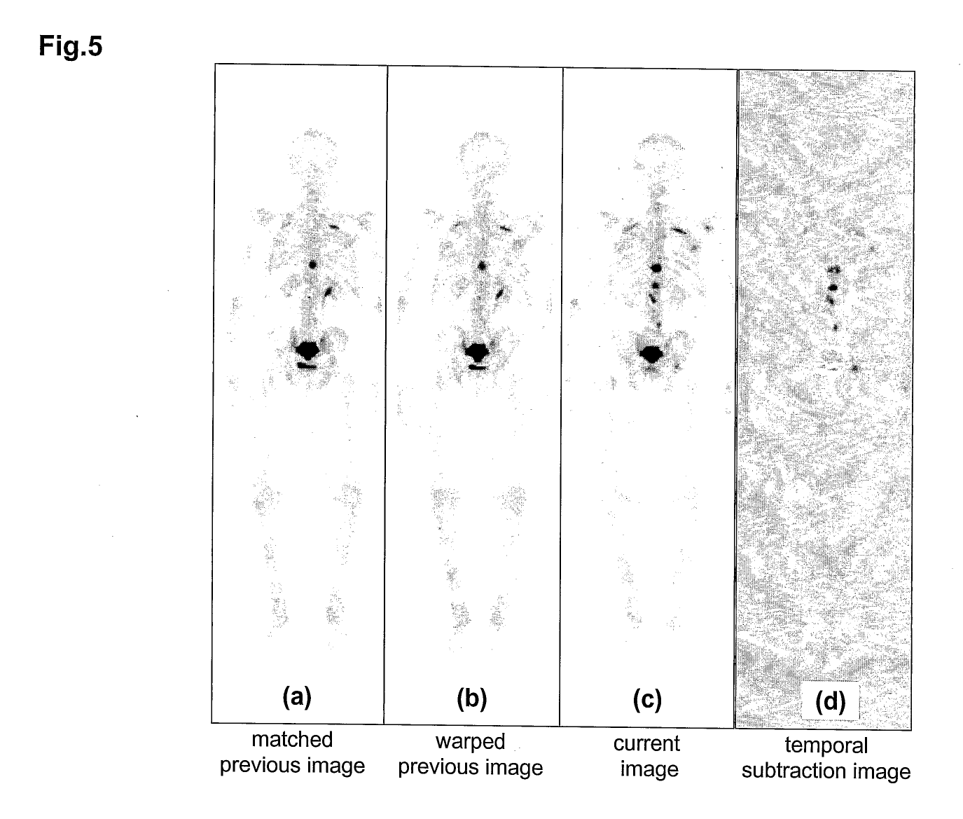

Once the final shift vectors for all ROIs are obtained, a bilinear interpolation technique may be employed for determination of the shift vectors for all pixels over the entire previous image. The interpolated shift vectors may then be used to warp the previous image. Finally, the warped previous image may be subtracted pixel-by-pixel from the original image to provide the temporal subtraction image 220. In order to indicate both hot and cold regions in the temporal subtraction image, the base pixel value of 256 (25% of the maximum gray scale) may be added to the subtraction image. FIG. 5 shows posterior views of (a) the matched image and (b) the warped image of the previous scan, which was subtracted from (c) the current scan to provide (d) the temporal subtraction image.

As shown in the overall method in FIG. 1, the computerized method for the detection of interval changes includes four steps: including an initial identification of candidates for interval changes 240, image feature extraction of candidates for interval changes 260, removal of some false positives by use of a rule-based test 280, and display of the computer output for identified interval changes 300. Two types of interval changes, for hot and cold lesions, may be identified separately by use of the same techniques, but with different parameters. In addition, all of the procedures in the computerized method may be carried out separately for each view, and the overall performance for the detection of interval changes was evaluated based on the number of “gold standard” interval changes included in each case. Note that, in the temporal subtraction images, hot lesions appear as dark areas, whereas cold lesions appear as light areas. Therefore, hot-lesion images were created by elimination of cold lesions, i.e., by changing the pixel values in cold lesions to the base pixel value of 256. On the other hand, cold-lesion images may be created by reversing of the pixel values in the temporal subtraction image such that cold legions appeared as dark areas and hot lesions as light areas. Then cold-lesion images may be obtained by elimination of light areas in the same way as that used for hot-lesion images.

Candidates for interval changes in each view may be identified initially by use of a multiple thresholding technique for hot-lesion-enhanced and cold-lesion-enhanced images, which may be obtained from the hot-lesion and cold-lesion images, respectively. The pixel values of the hot-lesion enhanced image may be obtained from the same location of the hot-lesion image if the original pixel values in the previous image are greater than 30, which would be considered as the threshold pixel value for distinguishing hot lesions from both background noise and normal bone structures. In the same way, the pixel values of the cold lesions may be obtained if the original pixel values in the current images are greater than 30. The gray scales of the hot-lesion-enhanced and the cold-lesion-enhanced images may be normalized linearly by use of the upper 5% and 85% of the area under the histogram of pixel values included in the image. In addition, a Gaussian filter may be applied to the images normalized as described above in order to reduce some remaining noise in the image.

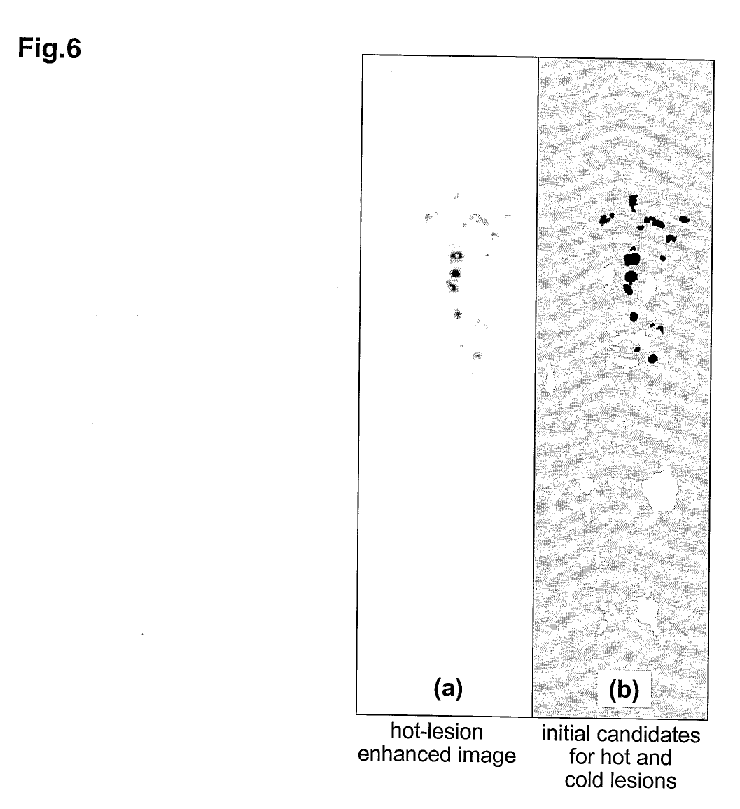

The multiple-gray-level thresholding technique [12] may be applied sequentially for identifying candidates of interval changes, by use of the area under the histogram of the lesion-enhanced image with an increment of 2%, until the threshold pixel value became less than 512 or the percentage of the area became 66% of the total area. Initial candidates of interval changes may be 1) identified if the centroid of the candidate, which is called an island here and is derived by multiple-gray-level thresholding, is not overlapped with the candidates identified in the previous threshold levels, and 2) if the effective diameter of the island is greater than 3.0 mm and less than 200.0 mm. In order to determine the contour of each candidate, a region-growing technique may be applied with a seed point over the centroid of the identified island. FIG. 6 illustrates (a) a hot-lesion-enhanced image and (b) initial candidates of hot (dark islands) and cold (light islands) lesions of interval changes obtained from successive bone scans that were shown in FIG. 5.

In the process of initial identification, ten image features were obtained based on the contour of an island in the hot-lesion/cold-lesion enhanced image as shown in FIG. 10, these include the 1) threshold value [%] at the initial identification level, 2) sequential order of the candidate among all of the candidates detected initially, 3) effective diameter [12], 4) circularity [12], 5) irregularity [12], 6) normalized vertical location, 7) contrast value obtained by the difference between the maximum and the minimum pixel values within the island, 8) average pixel value within the island, 9) standard deviation of pixel values within the island, and 10) difference in the pixel value between the inside and outside regions of the island, other features may also be used.

If the nonlinear image-warping technique does not work successfully for matching two images, misregistration artifacts may have occurred in the temporal subtraction image, with some false positives for interval changes. Therefore, in addition to the 10 initial image features, 4 addition image features were obtained (the contrast, average pixel value, standard deviation of the pixel value, and the difference between the inside and outside regions) from the warped previous image and also from the current image at the locations of identified candidates in order to examine the pixel values and image features in the original images.

A rule-based method [13] may be applied for removal of a number of false positives in each view. A number of image feature pairs may be determined for both hot and cold lesions by use of a two-dimensional linear discriminant analysis (LDA) method. In the present example of the present embodiment, the two-dimensional LDA method was first trained by use of all of the 58 case pairs and then was tested by use of the same case pairs.

Finally, all interval changes identified in each view and also in either hot or cold lesions were combined. Because some lesions had high intensities for both anterior and posterior views, one lesion (i.e., one truth) may be identified in both views or in either view. Therefore, an interval change was considered to be a true positive when the lesion was identified in either view, even if the truth was marked in both views by the radiologists. The interval change was considered to have been detected correctly, i.e., to be a true-positive detection, when the distance between the truth location identified by the radiologists and the centroid of the region of the identified interval change was less than 20 mm.

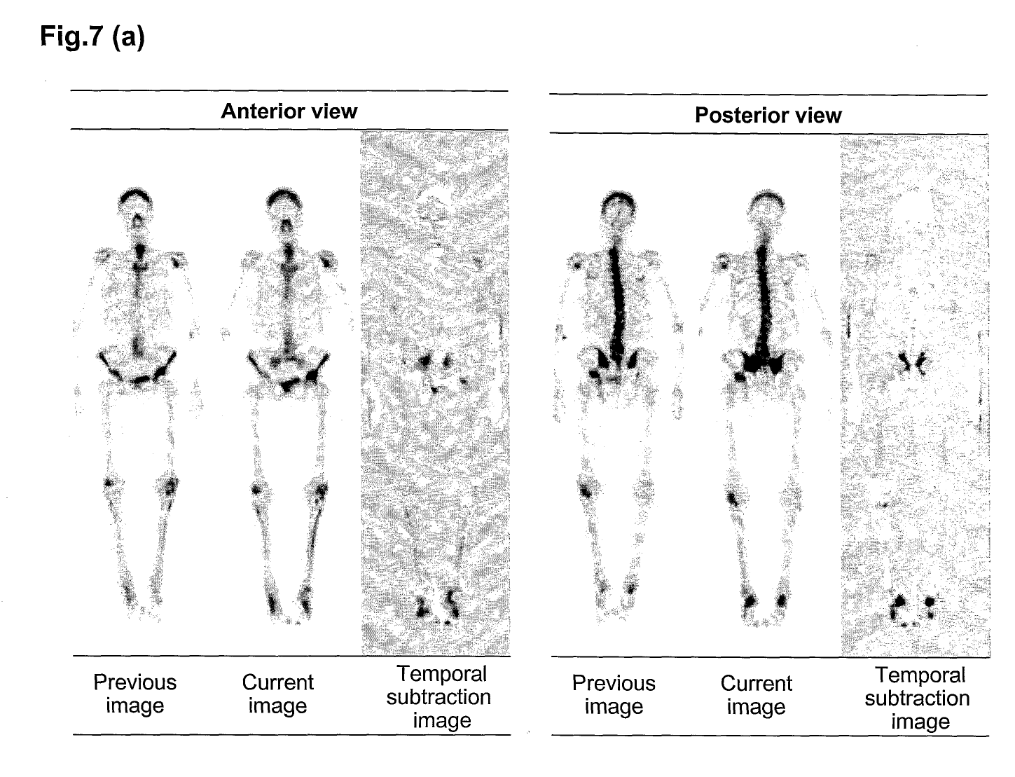

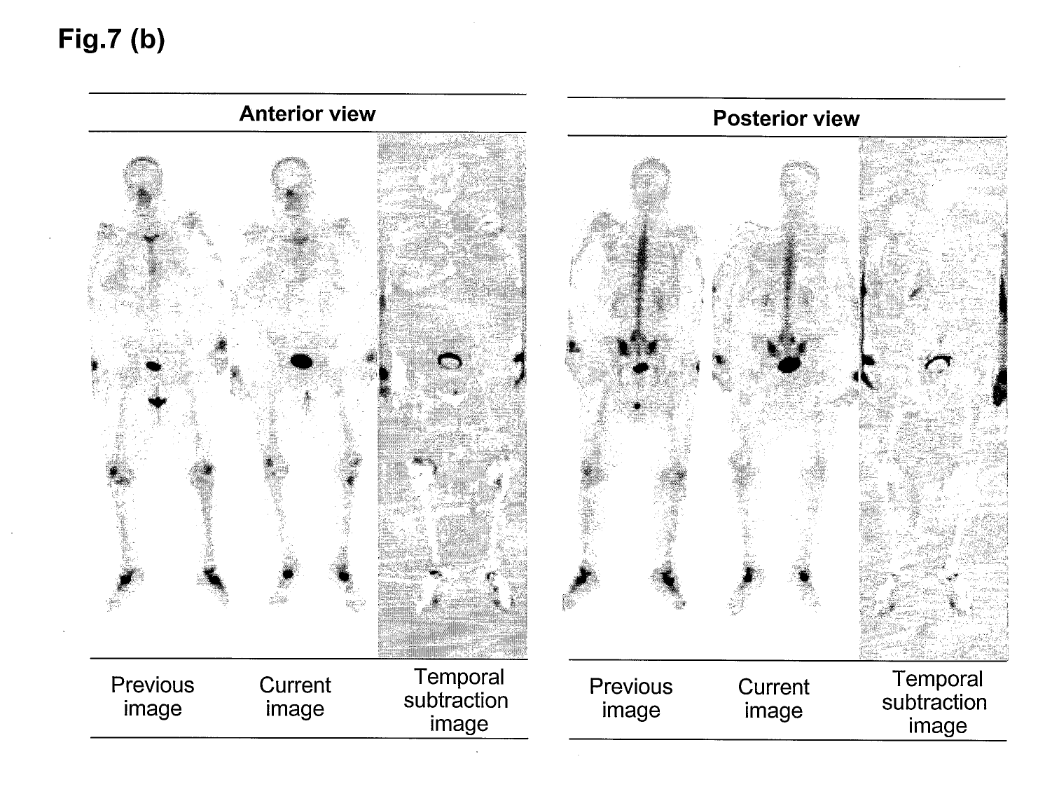

FIGS. 7 (a) and (b) show two examples of temporal subtraction images obtained from the method by use of the nonlinear image warping teclnique on previous and current images. In case (a), there are subtle new sacral-iliac lesions, which, given their symmetry, may not be detected routinely. In case (b), there has been a subtle change in the position of the left kidney which would not be detected routinely without a temporal subtraction image, and may indicate adjacent soft-tissue pathology.

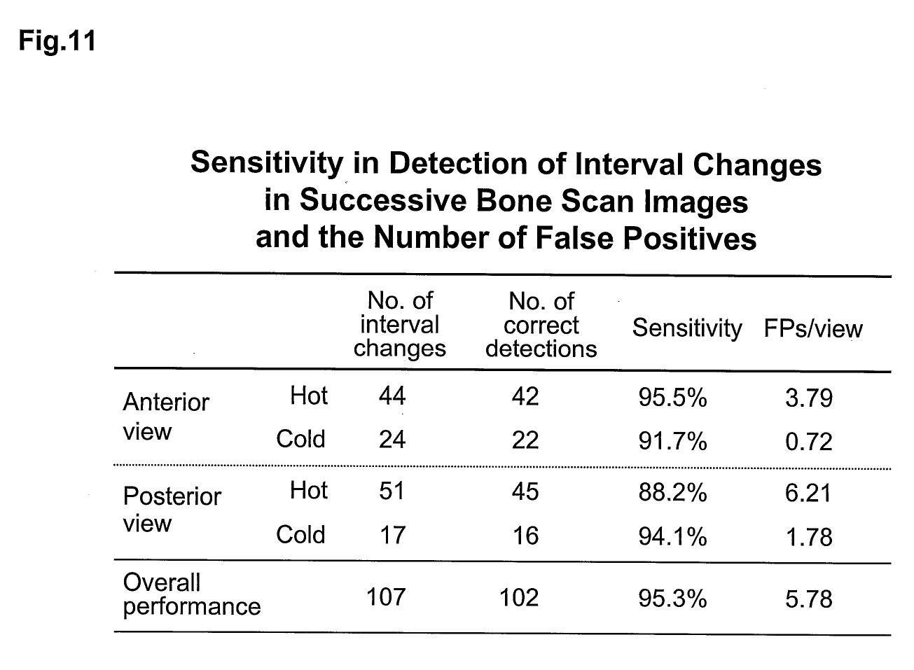

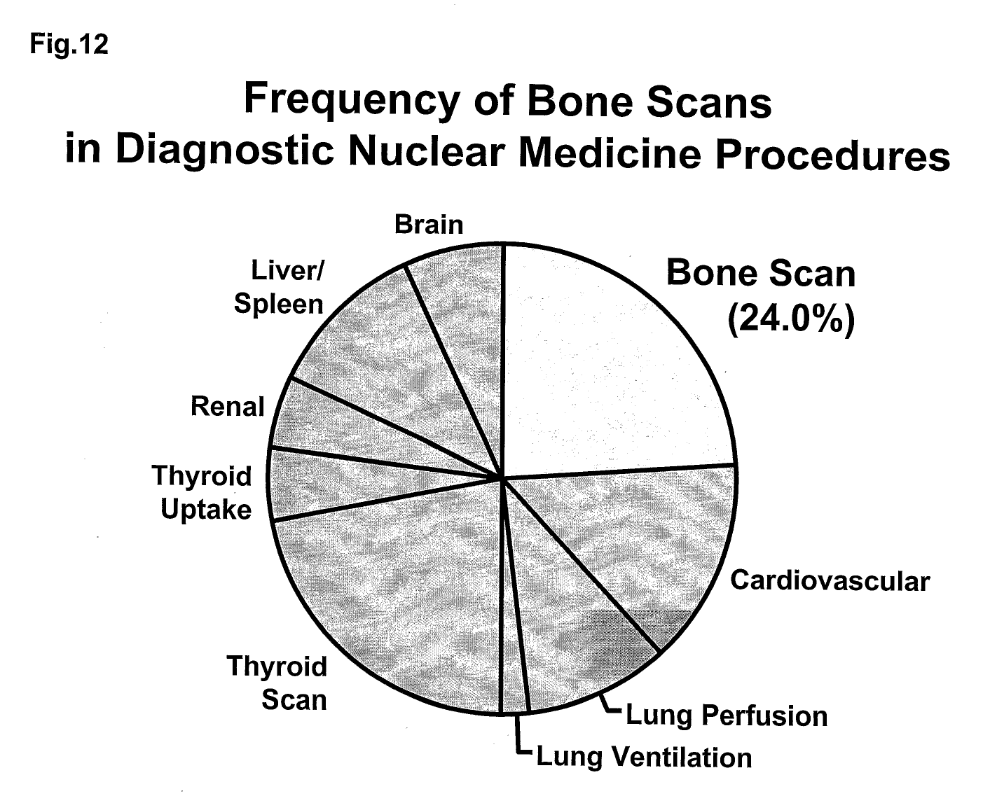

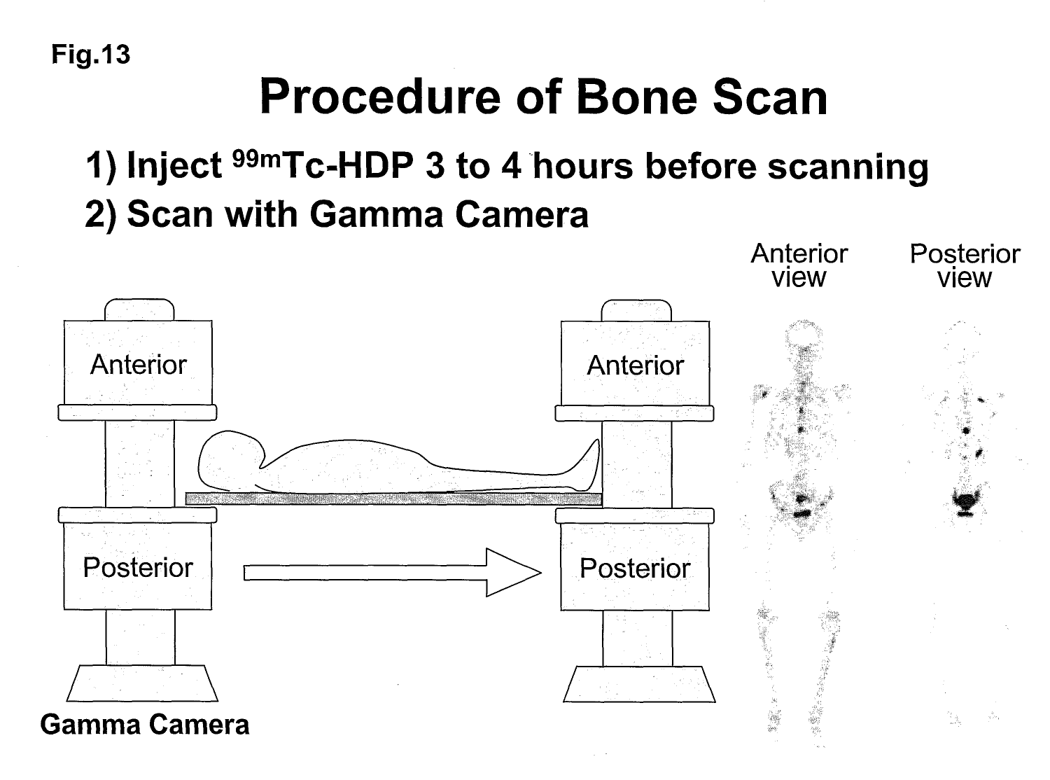

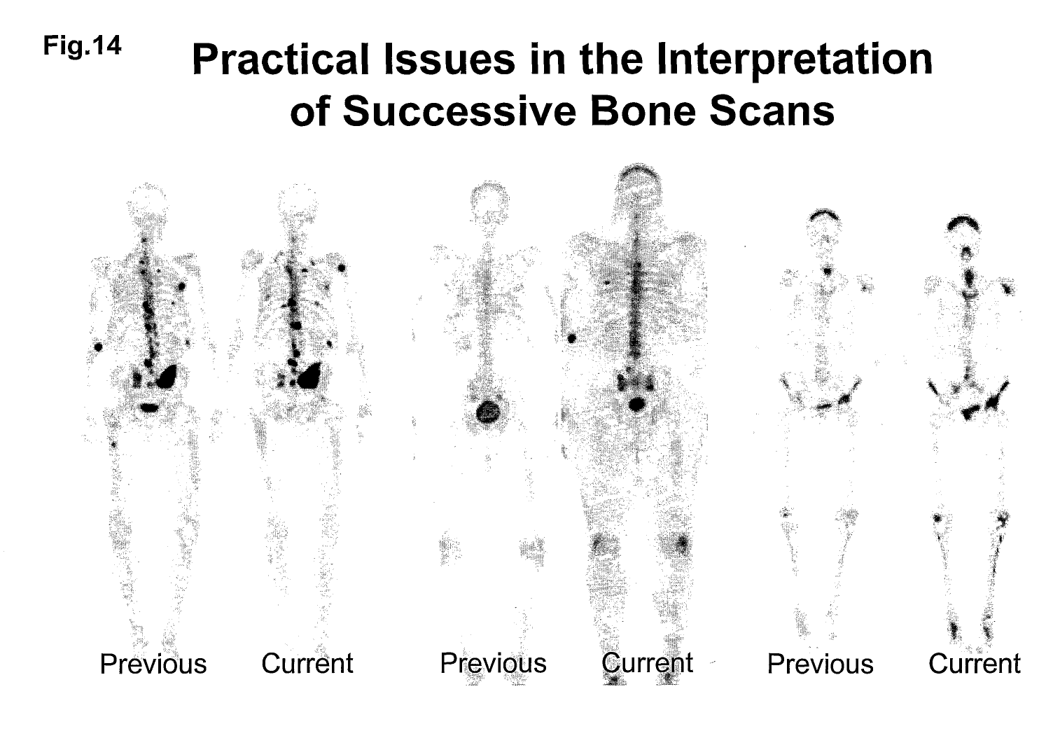

FIG. 11 shows the performance of the computerized method for the detection of interval changes in successive bone scans. The sensitivity and false positives per view in each view and in each type (hot/cold) of lesion were 95.5% and 3.79 for hot lesions on anterior views, 91.7% and 0.72 for cold lesions on anterior views, 88.2% and 6.21 for hot lesions on posterior views, and 94.1% and 1.78 for cold lesions on posterior views. The overall sensitivity in the detection of interval changes, including both hot and cold lesions, in 58 successive bone scan pairs was 95.3% with 5.78 false positives per view.

Recently, CAD has been used widely in radiologic research [14] and also in clinical situations [15]; however, there has been little CAD research on diagnostic nuclear-medicine images. Because of very low resolution of nuclear-medicine images and high sensitivity for abnormal lesions that could be activated by radioisotopes, radiologists might not have recognized the potential benefit provided by the assistance of a computerized method. However, the variation in image gray scales and in geometric image features, such as the size and orientation due to the positioning of patients, has frequently forced radiologists to perform difficult tasks for identifying or for quantifying subtle interval changes. Therefore, the present invention concludes that CAD methods would be useful in diagnostic nuclear-medicine examinations.

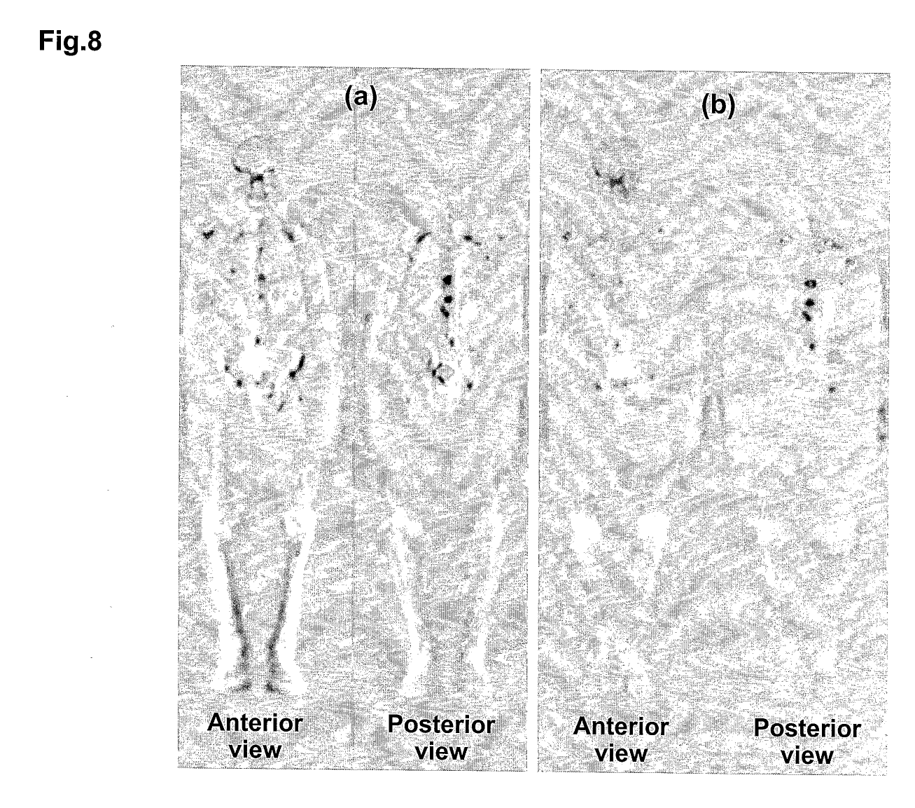

Thus the nonlinear image-warping technique [11] is useful in producing temporal subtraction images from successive whole-body bone scan images. Although the linear image conversion in terms of the size, orientation, and gray scale for matching a previous image to a current image was useful for comparing two images side-by-side, as shown in FIG. 2, a temporal subtraction image obtained with these two images was usually not very good. FIG. 8 illustrates two pairs of temporal subtraction images which were obtained from the same successive image pair of anterior and posterior views (a) without and (b) with the nonlinear image-warping technique. When the nonlinear image-warping technique was not applied for the temporal subtraction scheme, the subtraction image in FIG. 8 (a) included many artifacts caused by the misregistration. This effect can become more severe when the positioning of the patient was changed noticeably between the two examinations.

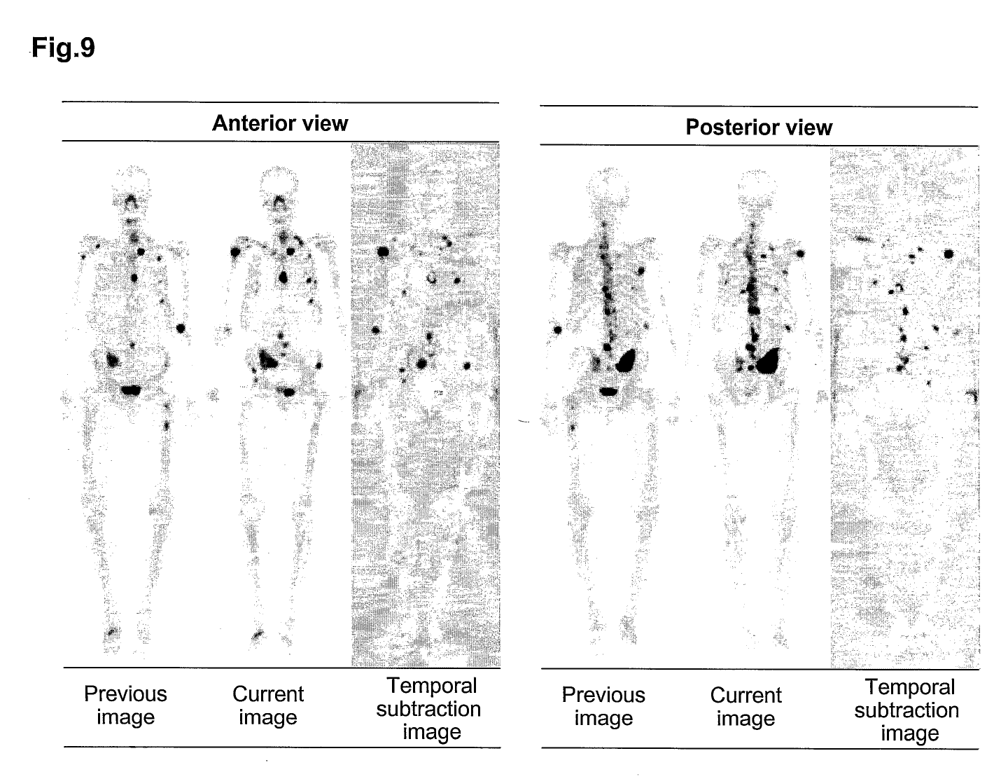

In the database, some pairs were excluded which had more than 20 interval changes between two successive bone scans, because it was very difficult to identify all changes as “gold standard” by three radiologists. In addition, the correct identification of a large number of interval changes in one patient may not be as important as the small number of interval changes in another patient. However, in the monitoring of progress for therapeutic effects by medication or radiation therapy, it may be very useful to identify and quantify all interval changes when many abnormal findings could be identified in both previous and current views. FIG. 9 shows an example of successive bone scan pairs which had a large number of abnormal lesions on both views as well as a large number of interval changes on the temporal subtraction images. This case was not included in the database used in this study; however, a large number of interval changes could be identified easily by use of the temporal subtraction images.

The performance of the present computerized method indicated a sensitivity of 95.3% and 5.78 false positives per view for 58 successive bone scan pairs. However, a number of false positives included some suspicious “true” interval changes which were identified by one or two radiologists but were not included in the “gold standard”. Because there was no way of determining the “truth” in an objective manner, complete agreement obtained from three experienced radiologists was used for determining the “gold standard.” Therefore, very subtle lesions were not considered as “gold standard” interval changes in most cases, although some of these lesions were identified by the computer.

The computer performance was obtained with the same training and test cases. The performance of a CAD method is preferably evaluated with little bias by use of a validated approach such as the jackknife method or the round-robin method, if the CAD method is to be applied in a clinical situation [16]. The present invention is believed to be applicable to any planar whole body exam, including the following list of exam listed roughly by most important to least: Gallium, Prostascint, Leukocyte/WBC, Neutrospect, MIBG, Octreoscan, Sulfur Colloid, Oncoscint, CEA Scan, Pyrophosphate, Whole body Sestamibi, Whole body Thallium. Other types of exam are also possible.

From the above discussion, it is believed clear that temporal subtraction images for successive whole-body bone scans may be used to assist radiologists in identifying subtle interval changes and in reducing the interpretation time of bone scan images when the images include multiple abnormal lesions. In addition, the temporal subtraction images obtained with the computerized method is useful for quantifying the interval changes even if the current image was very different from the previous image in terms of size, orientation, and gray scale.

Although further improvement of the computerized method may be necessary for reducing the number of false positives, the CAD method for the detection of interval changes by use of the temporal subtraction technique is useful in assisting radiologists' interpretation on successive bone scan images.

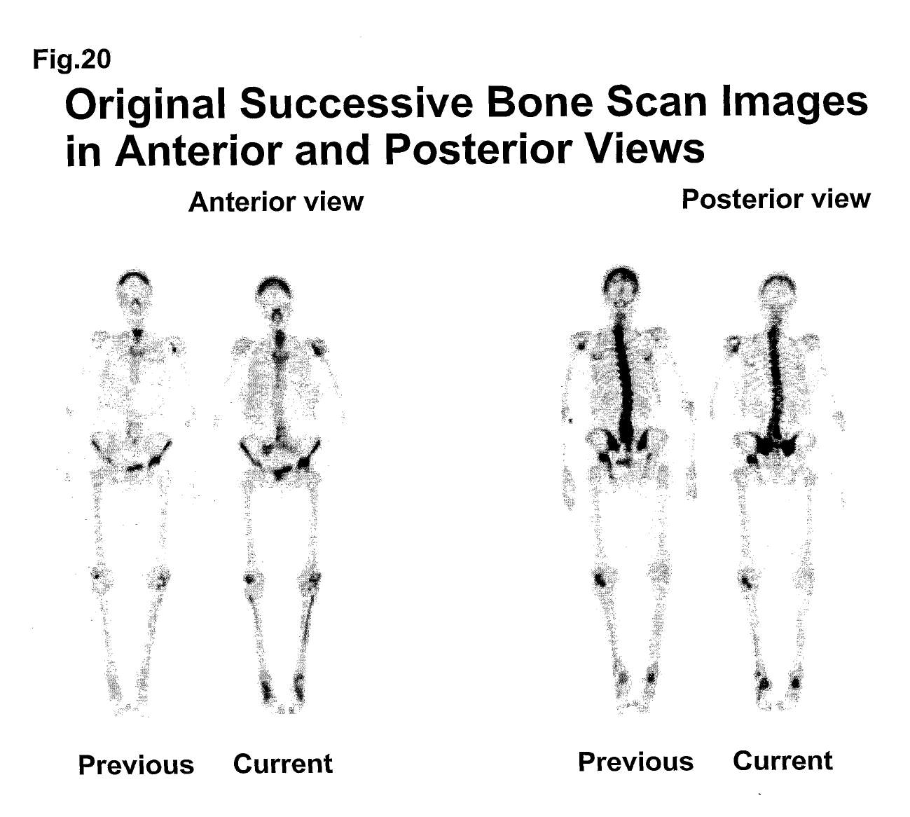

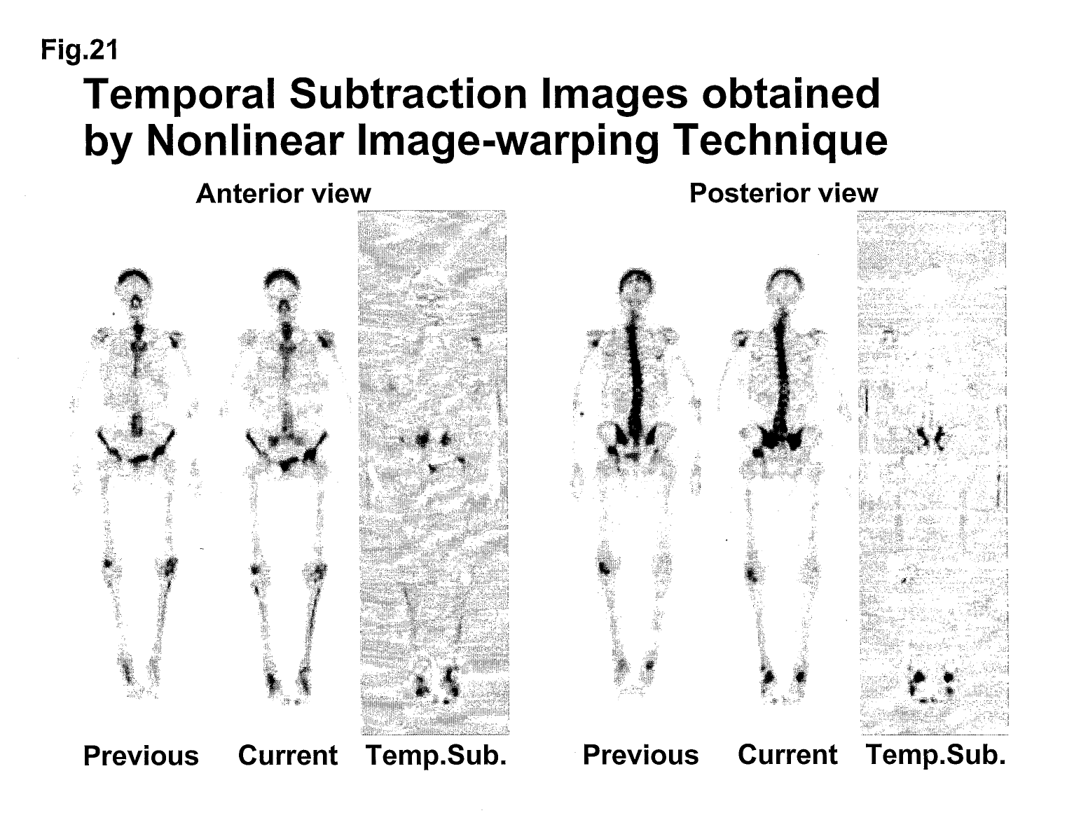

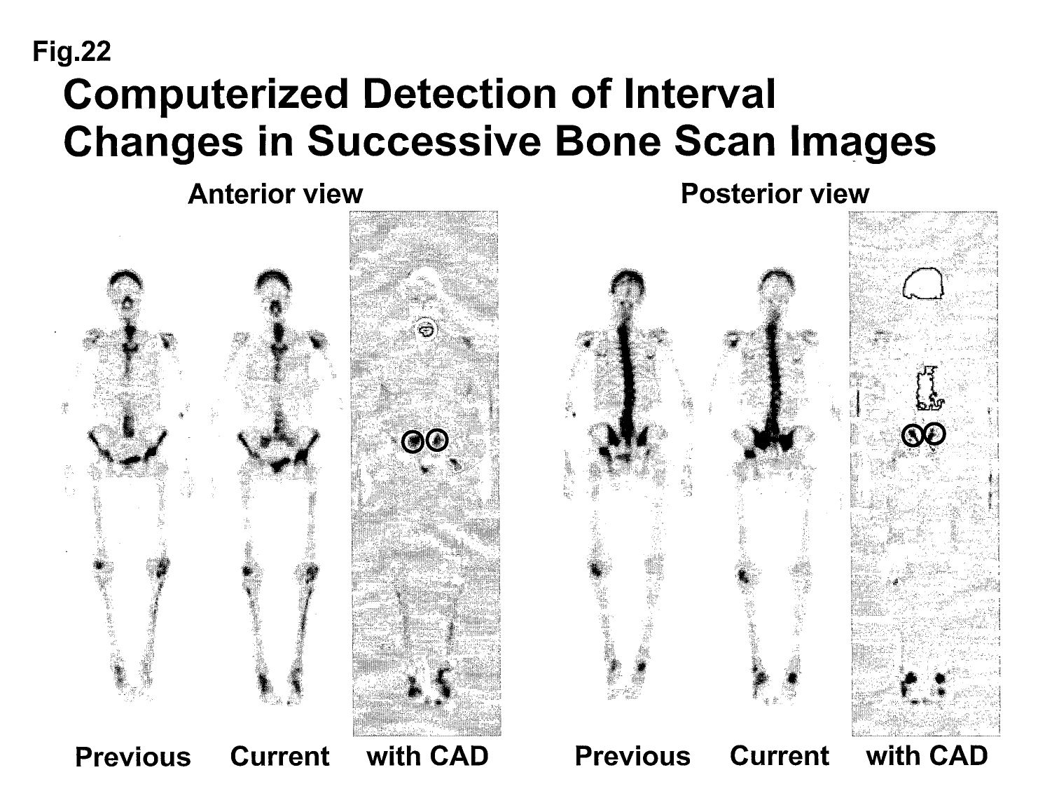

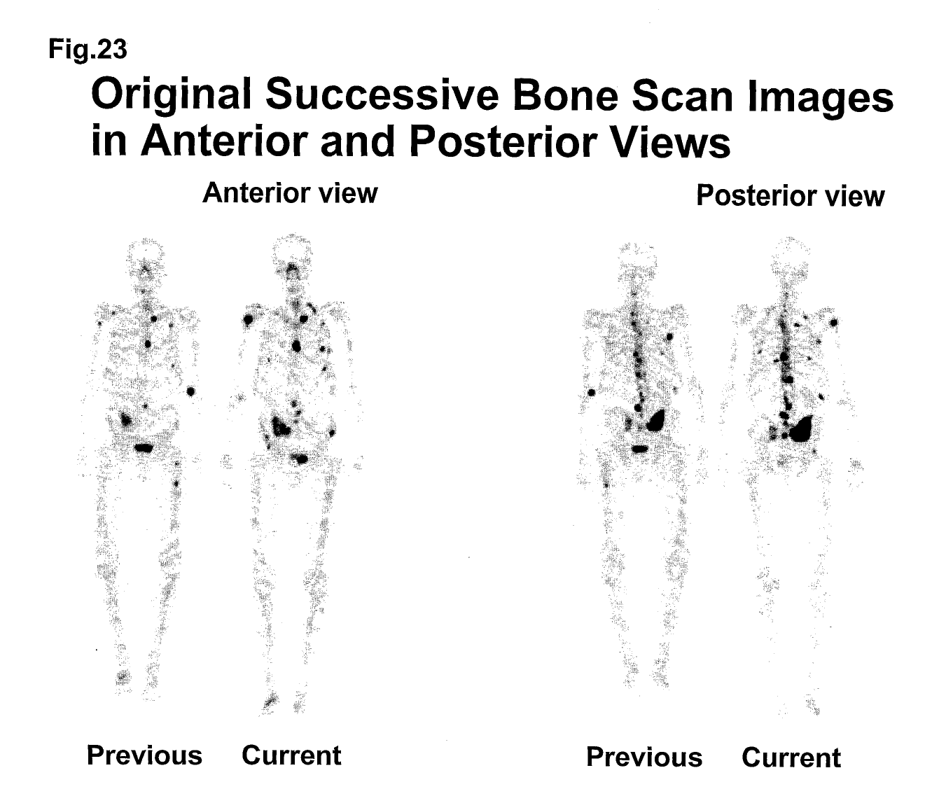

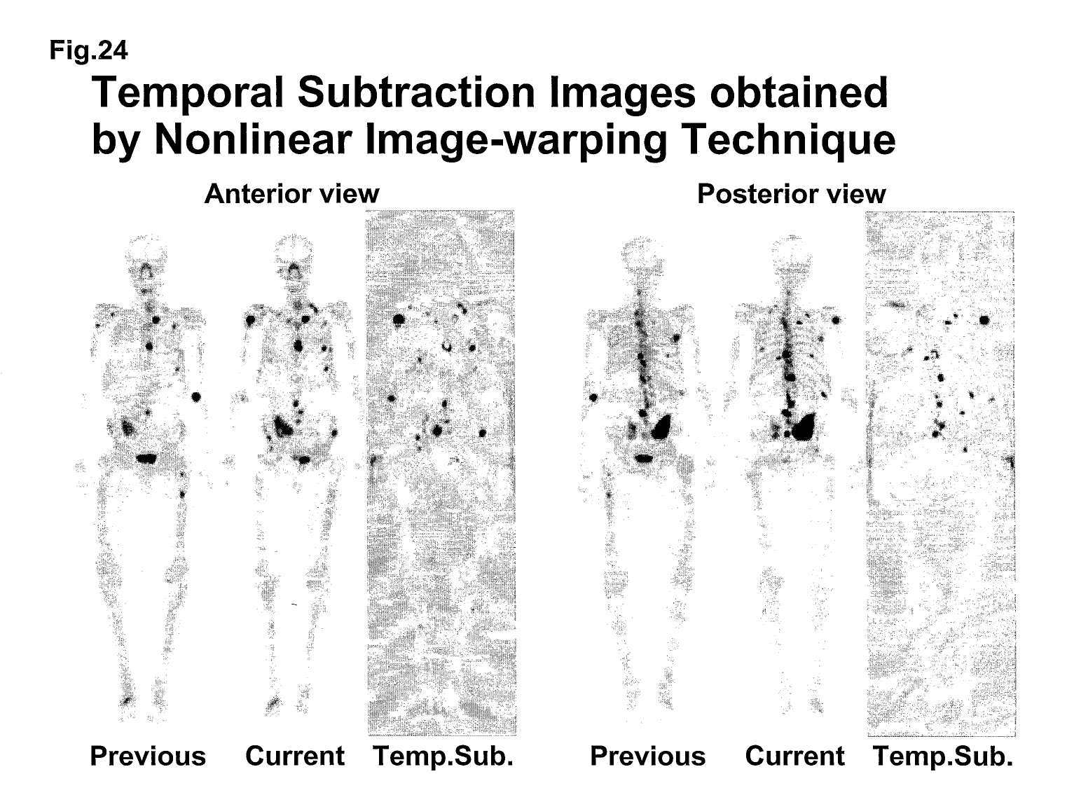

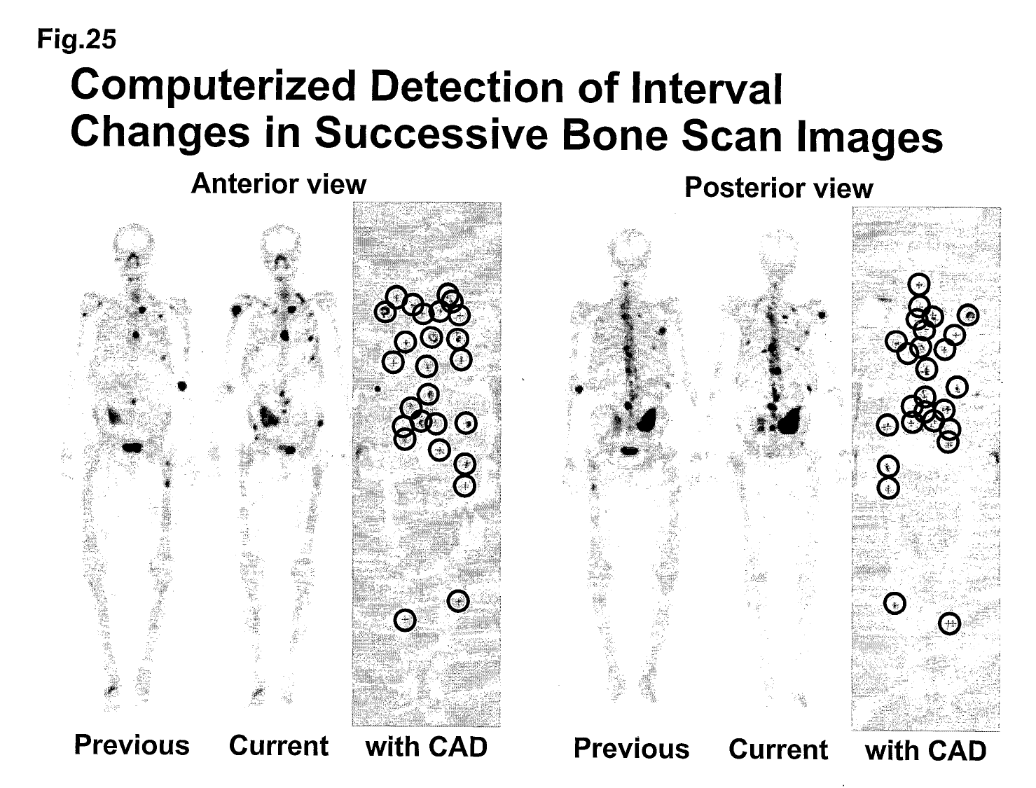

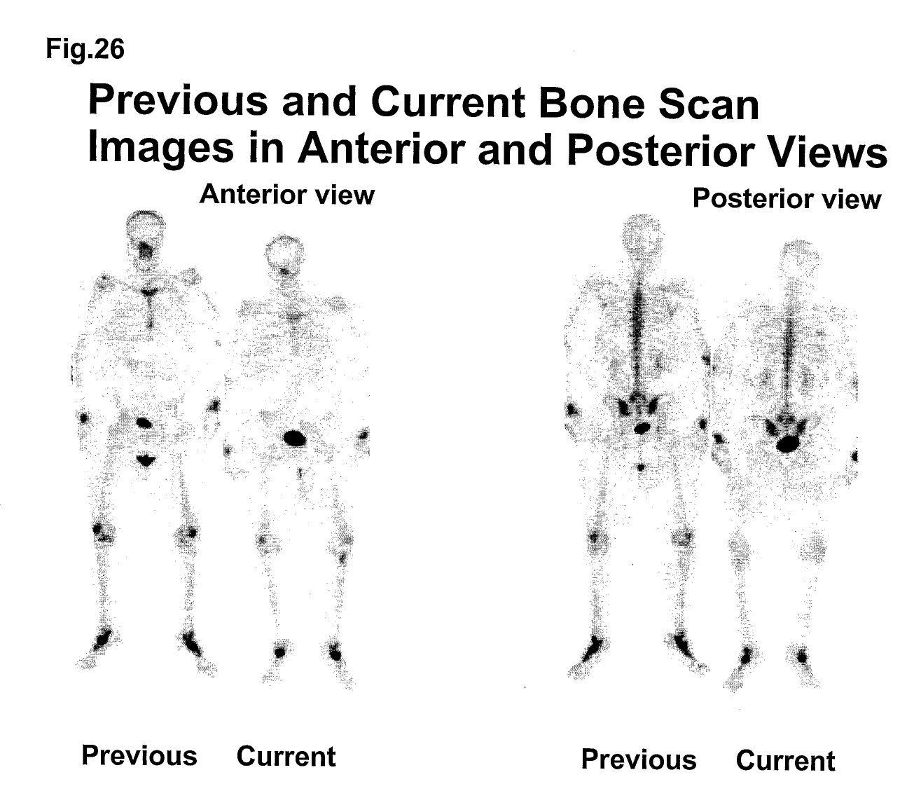

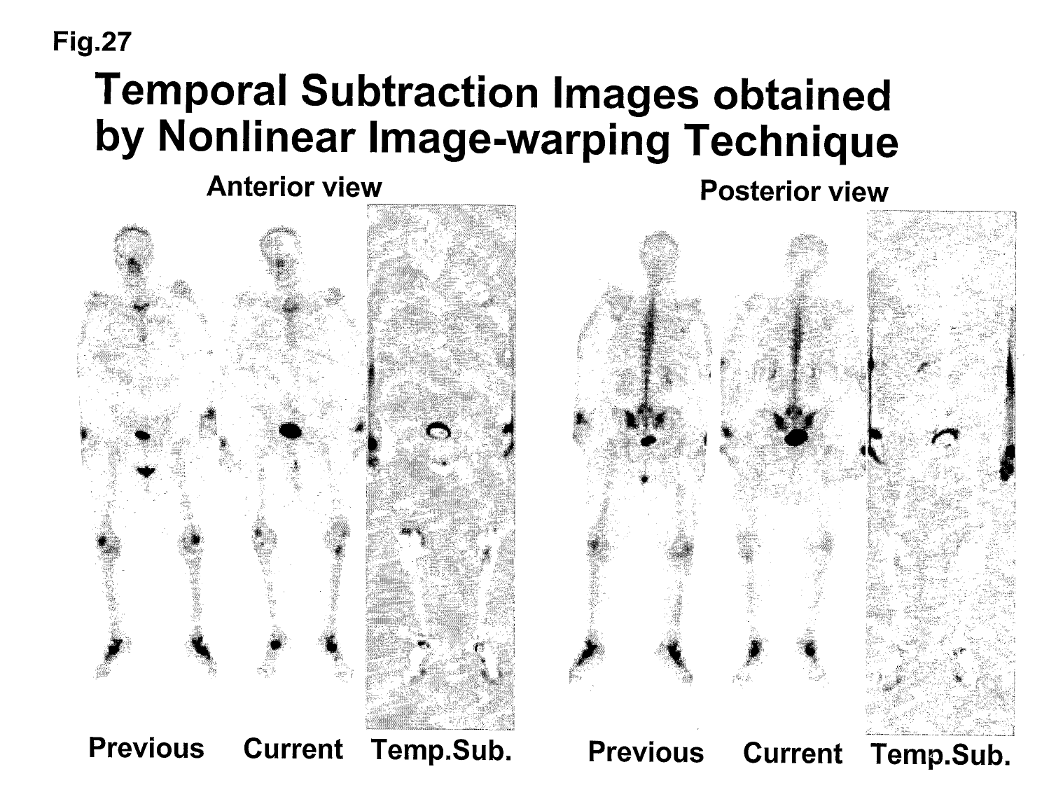

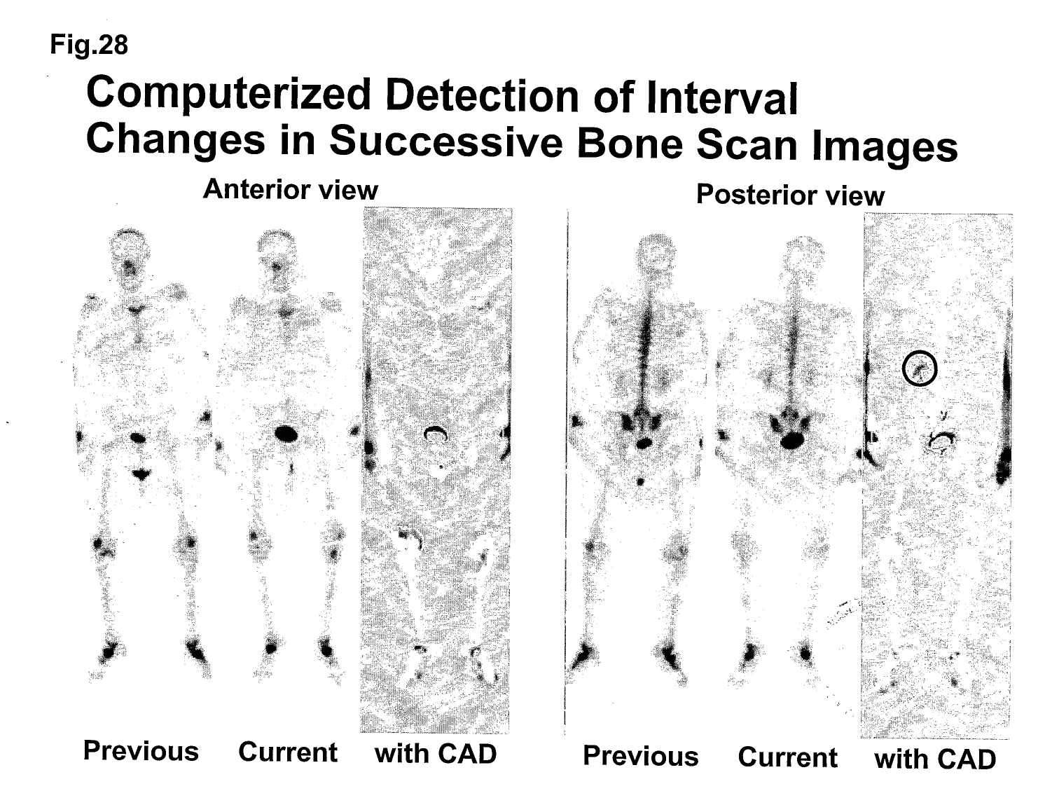

FIGS. 20-28 illustrate three examples of test cases using one method of the present invention. Each case 1-3 begins with previous and current bone scan images in anterior and posterior views FIGS. 20, 23 and 26. Then temporal subtraction images are obtained by the nonlinear image warping technique in FIGS. 21, 24 and 27. Finally, computerized detection of interval changes in successive bone scan images is performed in FIGS. 22, 25 and 28. As can be seen in FIGS. 22, 24 and 28 different test cases find a different number of interval changes. In FIG. 22 only a few positives are found while in FIG. 25 a large number are found.

All embodiments of the present invention conveniently may be implemented using a conventional general purpose computer or micro-processor programmed according to the teachings of the present invention, as will be apparent to those skilled in the computer art. Appropriate software may readily be prepared by programmers of ordinary skill based on the teachings of the present disclosure, as will be apparent to those skilled in the software art.

A computer 900 may implement the methods of the present invention, wherein the computer housing houses a motherboard which contains a CPU, memory (e.g., DRAM, ROM, EPROM, EEPROM, SRAM, SDRAM, and Flash RAM), and other optional special purpose logic devices (e.g., ASICS) or configurable logic devices (e.g., GAL and reprogrammable FPGA). The computer also includes plural input devices, (e.g., keyboard and mouse), and a display card for controlling a monitor. Additionally, the computer may include a floppy disk drive; other removable media devices (e.g. compact disc, tape, and removable magneto-optical media); and a hard disk or other fixed high density media drives, connected using an appropriate device bus (e.g., a SCSI bus, an Enhanced IDE bus, or an Ultra DMA bus). The computer may also include a compact disc reader, a compact disc reader/writer unit, or a compact disc jukebox, which may be connected to the same device bus or to another device bus.

Examples of computer readable media associated with the present invention include compact discs, hard disks, floppy disks, tape, magneto-optical disks, PROMs (e.g., EPROM, EEPROM, Flash EPROM), DRAM, SRAM, SDRAM, etc. Stored on any one or on a combination of these computer readable media, the present invention includes software for controlling both the hardware of the computer and for enabling the computer to interact with a human user. Such software may include, but is not limited to, device drivers, operating systems and user applications, such as development tools. Computer program products of the present invention include any computer readable medium which stores computer program instructions (e.g., computer code devices) which when executed by a computer causes the computer to perform the method of the present invention. The computer code devices of the present invention may be any interpretable or executable code mechanism, including but not limited to, scripts, interpreters, dynamic link libraries, Java classes, and complete executable programs. Moreover, parts of the processing of the present invention may be distributed (e.g., between (1) multiple CPUs or (2) at least one CPU and at least one configurable logic device) for better performance, reliability, and/or cost. For example, an outline or image may be selected on a first computer and sent to a second computer for remote diagnosis.

The present invention may also be complemented with additional filtering techniques and tools to account for image contrast, degree of irregularity, texture features, etc.

The invention may also be implemented by the preparation of application specific integrated circuits or by interconnecting an appropriate network of conventional component circuits, as will be readily apparent to those skilled in the art.

The source of image data to the present invention may be any appropriate image acquisition device such as an X-ray machine, CT apparatus, and MRI apparatus. Further, the acquired data may be digitized if not already in digital form. Alternatively, the source of image data being obtained and processed may be a memory storing data produced by an image acquisition device, and the memory may be local or remote, in which case a data communication network, such as PACS (Picture Archiving Computer System), may be used to access the image data for processing according to the present invention.

Numerous modifications and variations of the present invention are possible in light of the above teachings. For example, the invention may be applied to images other than MRA images.

Of course, the particular hardware or software implementation of the present invention may be varied while still remaining within the scope of the present invention. It is therefore to be understood that within the scope of the appended claims and their equivalents, the invention may be practiced otherwise than as specifically described herein.

1. A method of producing an image to aid detection of a change in progress of a disease in a patient, comprising:
obtaining a first image of a distribution of a radioisotope in the patient;
obtaining a second image of the distribution of the radioisotope in the patient;
normalizing at least one of the first and second images;
warping one of the images to match the other image using a multiple-segment matching method;
subtracting the first image from the second image to form a subtraction image; and
displaying the resulting subtraction image.

2. The method of claim 1, wherein the normalizing step comprises:
magnifying or reducing a size of one of the images to match a size of the other image;
rotating one of the images to match the other image; and
matching a gray scale of one of the images to match a gray scale of the other image.

3. The method of claim 2, wherein the magnifying step comprises:
adjusting the size of the two images based on a body size of the patient.

4. The method of claim 2, wherein the rotating step comprises:
adjusting the orientation of the two images based on a centerline of the patient.

5. The method of claim 2, wherein the matching step comprises:
adjusting the gray scale of one of the two images to match the gray scale of the other image based on a correlation and regression line between mean pixel values of corresponding pairs of small regions of interest in the images.

6. The method of claim 1, wherein the warping step comprises:
matching the two images;
partitioning the two images into multiple segments; and
warping the segments of one of the images to match the corresponding segments of the other image.

7. The method of claim 6, wherein the matching step comprises:
matching the two images based on an affine transform between corresponding pairs of regions of interest in the images.

8. The method of claim 7, comprising:
warping one of the images to match the other image based on the affine transform.

9. The method of claim 6, wherein the partitioning step comprises:
partitioning the images into segments showing the body of the patient or air.

10. The method of claim 9, comprising:
partitioning the segment of the body of the patient into segments of an upper body and a lower body.

11. The method of claim 6, wherein the step of warping the segments comprises:
correcting a difference in a location of the lower body of the patient between the two images.

12. The method of claim 6, wherein the step of warping the segments comprises:
matching distinct segments of one of the images to the corresponding segments of the other image with distinct matching techniques or distinct parameters.

13. The method of claim 6, wherein the step of warping the segments comprises:
matching the corresponding segments of the two images with an elastic matching technique.

14. A method of producing an image to aid detection of a change in progress of a disease in a patient, comprising:
obtaining a first image of a distribution of a radioisotope in the patient;
segmenting the first image into plural first segments;
obtaining a second image of the distribution of the radioisotope in the patient;
segmenting the second image into plural second segments;
matching segments of the first image to corresponding segments of the second image using the first and second segments;
magnifying or reducing a size of each of the first segments to match a size of the corresponding segment in the second image;
normalizing each segment;
applying a multiple-step image warping technique to each segment;
subtracting the segments of the first image from corresponding segments of the second image to form plural subtraction images;
combining the plural subtraction images to obtain a combined subtraction image; and
displaying the combined subtraction image.

15. The method of claim 14, further comprising:
gray-scale matching the first image to the second image after the obtaining a second image step and before the combining step.

16. The method of claim 14, further comprising:
rotating one of the images to match the other after the step of obtaining a second image and before the combining step.

17. The method of claim 14, further comprising:
applying computer-aided detection to the combined subtraction image.

18. The method of claim 17, further comprising:
displaying the results of the computer-aided detection.

19. The method of claim 17, wherein at least one region of interest found using computer-aided detection is labeled on at least one of the first image, the second image, and the subtraction image with a visual indicator corresponding to whether the region contains an increased radioisotope concentration or a decreased radioisotope concentration.

20. A computer program product which stores a sequence of computer program instructions which when executed by a computer programmed with the instructions, causes the computer to execute a process of producing an image to aid detection of a change in progress of a disease in a patient, said process comprising:
obtaining a first image of a distribution of a radioisotope in the patient;
segmenting the first image into plural first segments;
obtaining a second image of the distribution of the radioisotope in the patient;
segmenting the second image into plural second segments;
matching segments of the first image to corresponding segments of the second image using the first and second segments;
magnifying or reducing a size of each of the first segments to match a size of the corresponding segment in the second image;
normalizing each segment;
applying a multiple-step image warping technique to each segment;
subtracting the segments of the first image from corresponding segments of the second image to form plural subtraction images;
combining the plural subtraction images to obtain a combined subtraction image; and
displaying the combined subtraction image.

21. A computer program product which stores a sequence of computer program instructions which when executed by a computer programmed with the instructions, causes the computer to execute a process of producing an image to aid detection of a change in progress of a disease in a patient, said process comprising:
obtaining a first image of a distribution of a radioisotope in the patient;
obtaining a second image of the distribution of the radioisotope in the patient;
normalizing at least one of the first and second images;
warping one of the images to match the other image using a multiple-segment matching method;
subtracting the first image from the second image to form a subtraction image; and
displaying the resulting subtraction image.

22. A system configured to produce an image to aid detection of a change in progress of a disease in a patient, comprising:
a device configured to obtain a first image of a distribution of a radioisotope in the patient;
a device configured to segment the first image into plural first segments;
a device configured to obtain a second image of the distribution of the radioisotope in the patient;
a device configured to segment the second image into plural second segments;
a device configured to match segments of the first image to corresponding segments of the second image using the first and second segments;
a device configured to magnify or reducing a size of each of the first segments to match a size of the corresponding segment in the second image;
a device configured to normalize each segment;
a device configured to apply a multiple-step image warping technique to each segment;
a device configured to subtract the segments of the first image from corresponding segments of the second image to form plural subtraction images;
a device configured to combine the plural subtraction images to obtain a combined subtraction image; and
a display configured to display the combined subtraction image.

23. A system configured to produce an image to aid detection of a change in progress of a disease in a patient, comprising:
a device configured to obtain a first image of a distribution of a radioisotope in the patient;
a device configured to obtain a second image of the distribution of the radioisotope in the patient;
a device configured to normalize at least one of the first and second images;
a device configured to warp one of the images to match the other image using a multiple-segment matching method;
a device configured to subtract the first image from the second image to form a subtraction image; and
a display configured to display the resulting subtraction image.
